(19) United States
(12) Patent Application Publication
(10) Pub. No.: US 2024/0117791 A1
(43) Pub. Date: Apr. 11, 2024

(54) A Turbine Provided with Data for Parameter Improvement

(71) Applicant: Wind Farm Analytics Ltd., Glasgow (GB)

(72) Inventor: Theodore HOLTOM, Glasgow (GB)

(21) Appl. No.: 18/276,229

(22) PCT Filed: Feb. 9, 2022
(86) PCT No.: PCT/GB2022/050339

§ 371 Date: Aug. 7, 2023

(30) Foreign Application Priority Data
Feb. 11, 2021 (GB) 2101919.5

(51) Int. Cl. F03D 17/00

(52) U.S. Cl. CPC F03D 17/011; F03D 17/003

(57) ABSTRACT

Turbines, including fluid driven turbines, including wind turbines, do not always operate to their maximum capability due to sub-optimal selection of various possible parameters. Therefore there is industrial advantage in systems which can calculate, adjust or constrain such parameters in order to improve the productivity of turbines. New data also allows for new control methodologies. Such systems may be established through the provision of relevant data. The overall productivity of turbines may be improved, or increased, by extending the lifetime of the turbine, or by increasing the average power output during its lifetime, or reducing maintenance costs. One particular example of turbine under-performance has been observed by the present author for wind turbines operating in hilly terrain such as frequently found on Scottish wind farms but also in many locations around the world. Hilly terrain, or complex terrain, results in complex wind flow and energy production losses when control systems are not best designed to handle such flow. Although complex flow may arise for other reasons, such as complex weather or storms (both onshore and offshore), the complex flow due to complex terrain is always present for many turbines and therefore impacts productivity throughout their operational lifetime. Complex fluid flow data may be measured by instruments including converging beam Doppler LIDAR which is especially advantageous in providing three-dimensional fluid velocity data. Therefore the provision of data allows for control parameter adjustment to account for operational variables including fluid characteristics. Therefore the control parameters may be adjusted in order to better control a turbine for its local conditions. This allows for greater generation of renewable energy. Derivations thereof may also be applied to improve operational parameters of vehicles, including vehicles incorporating a rotor, as well as aircraft and spacecraft launching or operating within a fluid. This offers better vehicle control and improved safety.

Turbines, including fluid driven turbines, including wind turbines, do not always operate to their maximum capability due to sub-optimal selection of various possible parameters. Therefore there is industrial advantage in systems which can calculate, adjust or constrain such parameters in order to improve the productivity of turbines. Such systems may be established through the provision of relevant data.

The overall productivity of turbines may be improved, or increased, by extending the lifetime of the turbine, or by increasing the average power output during its lifetime, or reducing maintenance costs.

One particular example of turbine under-performance has been observed by the present author for wind turbines operating in hilly terrain such as frequently found on Scottish wind farms but also in many locations around the world. Hilly terrain, or complex terrain, results in complex wind flow. Although complex flow may arise for other reasons, such as complex weather or storms (both onshore and offshore), the complex flow due to complex terrain is always present for many turbines and therefore impacts productivity throughout their operational lifetime.

Although the present invention is especially aimed at wind turbines, it is considered that the same invention may apply also to other types of fluid driven turbine, such as tidal flow turbines.

A wind turbine may be a horizontal axis wind turbine (HAWT). Despite this “horizontal” terminology it is commonly the case that the axis of a horizontal axis wind turbine also incorporates a tilt angle to the horizontal plane such that the axis is not horizontal. This angle may commonly be approximately 5 degrees to the horizontal plane. A wind turbine may also be a vertical axis wind turbine. In principle a turbine rotor axis, whether wind turbine or other type of turbine, such as but not limited to tidal turbine, may be at any angle or orientation. In any case so-called horizontal axis wind turbines have become the usual design within the global wind industry. Normally the “horizontal” rotor axis and its drive train, optionally including a gear box and high speed shaft into a generator, is mounted on a motorised yaw ring so that one or more motors may turn the vertical plane containing the rotor axis to point into the main wind direction which may be at any compass bearing 0-360 degrees relative to north. Usually the yaw ring is in a horizontal plane and its vertical yaw rotation axis is coincident with the vertical central axis of a tower, which may be cylindrical or a slightly tapered cylinder but in principle can be of any shape which does not obstruct rotor rotation. The rotor shaft is rotated about the rotor axis by virtue of its attachment to a rotor consisting of rotor hub and one or more blades. The blades may commonly pitch around an axis along the blade length with pitch motorisation (optionally electric, optionally hydraulic) typically at the blade root where it meets the rotor hub. The blades are along most of their length similar in aerodynamic cross section to an aeroplane wing. However, a wind turbine tip experiences much faster airspeed than a blade element at a lower radius, whereas an aeroplane wing experiences the same airspeed along its length. The blade motion is in a roughly vertical plane, albeit tilted typically by approximately 5 degrees from the vertical due to a typical rotor axis tilt. Therefore the relative wind speed and angle of attack arises from a combination of absolute wind velocity, which is generally horizontal, and blade motion within an approximately vertical plane. The tip speed may be much faster than the wind speed, whereas the inner rotor near the blade root is rotating at a much slower linear speed (as opposed to angular speed). The linear speed of any blade element increases with its radius from the rotor axis toward the blade tip. Therefore, to account for this variation in aerodynamic conditions along the length of the blade, at least in part, the aerodynamic chord between the air-foil leading edge and trailing edge is commonly twisted at different angles along the length of the HAWT blade.

A direct drive wind turbine rotor typically drives an electromagnetic generator directly whereas a geared wind turbine employs gearing on the rotor shaft to typically step up the rotor speed to a high speed shaft which may run a high speed electromagnetic generator. In principle a wind turbine rotor, or more generally a turbine rotor, may be used as a mechanical motor to drive a device other than an electromagnetic generator, such as a mechanical pump or compressor.

Farmers have often used wind turbines to drive water pumps. However, most industrial wind turbines are used for electricity generation.

A wind farm, of one or more wind turbine, commonly consists of a site electrical network connected to a substation with a connection point or export point denoting connection to a wider electrical grid or network outside of the wind farm boundary. A wind farm or a wind turbine has a physical boundary as well as an electrical boundary. A wind turbine foundation may be of various designs onshore, and may also be offshore, including the possibility of a floating foundation. A wind farm boundary may typically span land or sea bed, owned by one or more land owner according to one or more system of law. A wind farm planning process is usually undertaken to plan all aspects of a wind farm including but not limited to environmental, grid connection and regulatory requirements, as well as physical design aspects of what turbine models (including rotor size, tower height, turbine classification) and turbine layout will yield most energy, and financial planning to calculate what will be the capital cost of equipment, cost of installation, operation and maintenance costs, likely price for energy export and project lifetime.

The present invention offers a system for improving parameters of a turbine based on data. The improvement results in greater electricity export over the asset lifetime. This may arise firstly through harvesting more wind power on average during any given operational year. Secondly the asset lifetime may be increased due to the lowering of operational loads, which in turn reduces component failures and maintenance costs, and/or reduces fatigue loads throughout the operational lifetime. Extreme loads may also be reduced. There are numerous mechanisms by which data can be used to improve the parameters of turbines to these ends.

In particular it is proposed that provision of three-dimensional flow data may allow calculation, adjustment or constraint of parameters toward improving turbine productivity. Such data may be arrived at through measurement using instruments such as but not limited to three-dimensional ultrasonic instruments, which may be deployed directly mounted on an operational turbine, or mounted on a mast prior to installation of a turbine or nearby an operational turbine.

It is noted that three-dimensional ultrasonic instruments are one type of wind flow sensor but other types of wind flow sensor, or more generally fluidic flow sensor, are known in the art and could also be used to supply three-dimensional flow measurement.

The wind industry has often used instruments which provide only two-dimensional wind measurement within a horizontal plane such as wind vanes and spinning cup anemometers with a vertical axis of rotation. These instruments have a severe disadvantage in complex flow which includes a significant vertical component, due to their inability to measure vertical components.

The wind industry has often employed Doppler LIDAR (Light Detection and Ranging), a method of laser wind measurement which has an advantage over physical instruments in that the laser beam is a form of remote sensing which does not significantly alter the flow of the fluid whose velocity is being measured whereas a physical mast- or turbine-mounted instrument provides a measurement which is subject to an error due to the fluid flow being altered by the mast or turbine structure itself.

A LIDAR may be “ground mounted” which may indicate a LIDAR box placed on the ground, optionally with legs, optionally mounted on a tripod. It will be appreciated that a LIDAR may be mounted on a structure such as a mast in order to obtain a different field of view, possibly for purpose of seeing over forestry or other features.

Doppler LIDAR, known to those skilled in the art, works by measuring the change in frequency between an emitted light and a reflected portion of the light. Typically the receiver is co-located, or practically co-located, with the emitter. In this case the Doppler LIDAR only provides a measurement of Doppler shift along the LIDAR line of sight. The reflection, or scattering, occurs either from molecules of the fluid, or from aerosols or particulates borne within the fluid. The Doppler shift in frequency therefore indicates the relative line of sight velocity of the fluid but does not provide any indication of the fluid velocity which is orthogonal to the laser beam/LIDAR line of sight. In order to produce a three-dimensional velocity measurement using Doppler LIDAR one needs three distinct lines of sight.

The range of the measurement from the LIDAR transmitter-receiver (transceiver) may be governed by a timing gate and use of a LIDAR pulse. Alternatively for continuous wave (CW) systems the measurement range can be governed according to focusing in range such that the dominant signal portion arrives from the focus range.

One method of applying LIDAR within the wind industry is to sweep out a cone in a conical scan so that a plurality of different lines of sight are provided. However, this means that for a given measurement range each line of sight measurement is from a different location around a circle on the cone. Therefore by combining the Doppler shifts from around a circle a three-dimensional velocity may be provided but this is an average around the circle. We may describe this arrangement as a “diverging beam” LIDAR since the beams providing different velocity components are diverging at different angles from a common source.

If the three-dimensional wind velocity is constant around the circle then the average is an accurate measurement and it does not matter where the samples are gathered around that circle. However, in practice the circle may have large diameter, such as but not limited to approximately one hundred metres or more. In reality the wind velocity is often quite variable through space and time, implying that this conical scan measurement method suffers from ambiguity and error. Other diverging beam approaches, such as Doppler Beam Swinging, or scanning a single beam through different angles, or combining multiple beams which are not arranged to converge at a measurement point, suffer the same problem thanks to combining different velocity components, from different points in space, into a single reconstructed velocity. One may ask the question—are you assuming the wind velocity is constant? If the wind velocity is not constant through space then which point in space is this measurement supposed to be for?

It is here contemplated that a plurality of beams may scan through multiple points in space very quickly, without actually converging or intersecting, but that this is entirely equivalent when the beams commonly intersect a measurement locale in space-time where the measurement locale surrounds an intended measurement point at a specific location within space-time. The important point is that the system is designed in order to collect a plurality of Doppler velocity components which are intended to represent the fluid velocity component at the chosen location within space-time. Over a small spatial locale surrounding the location, and during a small temporal locale, it is reasonable to assume the fluid velocity is constant. The important feature of the system is that it is designed to collect a plurality of Doppler velocity components along different (non-co-planar) lines of sight toward a chosen point in space-time. This is quite different from any system which is designed to collect a plurality of fluid velocity components not at the same chosen point in space-time, where the measurement beams are not aimed from different directions toward the chosen point in space-time.

It is appreciated that a fluid flow may incorporate a turbulence spectrum and that there are a variety of turbulence length scales and turbulence time scales. Turbulence variation of the wind velocity may be considered in three-dimensions rather than a one-dimensional variation along the main wind direction. If a measurement is performed by integration or averaging over a range in position or time then the measurement device may not be capable to resolve turbulence length scales or turbulence time scales which are smaller than the integration or averaging range in position or time respectively. Conversely the measurement device may not capture energy within turbulence length or time scales which are greater than the integration over position or time respectively.

A velocity measurement device acts as a velocity filter, or in an optical analogy as a lens through which light from the world is refracted and/or diffracted. An optical component has an optical wavelength bandwidth—it may potentially transmit only visible light but not microwaves, for example. Analogously a velocity or turbulence measurement device has a velocity or turbulence bandwidth.

It is noted that if different beams are arranged to converge at a single measurement position but at different points in time then this will result in fluid velocity reconstruction error due to temporal variation in fluid flow. To eliminate ambiguity and measurement error then it is advantageous that three or more beams are arranged to converge, as best as possible within practical constraints, to the same point in space-time; in other words that the beams are deliberately arranged to converge to the same given point in space at a given point in time. Such convergence may be obtained manually, by use of positioning and alignment tools and/or sensors, or else automatically via a calibrated beam steering system, itself positioned and aligned by use of tools and/or sensors. The point in space-time may be deliberately chosen by design, rather than accidentally arrived at by chance. A measurement point may be calculated or programmed. An instruction for measurement at a specific point in space-time may be received via data transfer.

In practice a measurement involves some spatial and temporal averaging in order to detect an appreciable signal for signal processing. For instance, but without loss of generality, a pulsed LIDAR system may average many hundreds of pulses within a very small fraction of a second of time which means that the measurement is not precisely instantaneous in time, even though the signal averaged over many pulses may be reasonably treated as a single instantaneous measurement for many practical purposes. Also each pulse has a very small duration which means that, when using timing gates to set a measurement range, we do not know if a received reflection at a given time arises from reflection of energy from the beginning or middle or end of a pulse. In fact the signal gathered at a given moment in time may include a continuum of components which were reflected from a continuous range comparable to the pulse length in space which arises from its pulse duration in time combined with the pulse speed of travel through the fluid.

In case of LIDAR wind measurement we are considering the speed of light in air which depends on the refractive index of light in air, which may depend on its density and other parameters. In principle the LIDAR may be provided with air density and other parameters in order to adjust the LIDAR signal processing, including pulsed LIDAR timing gates and therefore the measurement range, for a varying refractive index. For a continuous wave (CW) LIDAR with a controllable focus, whether using optical path switching or optical path adjustment, including mechanical adjustment of a lens position or non-mechanical means of focal control (including focal length/range control and beam width and/or intensity) such as but not limited to electro-optical control of lens properties, the focal control may also depend on the properties of the transmitting medium such as, though not limited to, air density. Therefore a CW LIDAR range focus control may also benefit from the provision of data regarding the optical medium. It is appreciated that parameters of a medium such as but not limited to density, temperature, pressure, molecular composition, humidity, force fields such as gravitational, electrical or magnetic fields, are parameters which may be varying. Therefore it can be possible to supply a system, including a LIDAR measurement system, with such parameters as an overall average indicating the general situation, or indeed at a plurality of points through time and space in order to account for variation of such parameters through the system's space-time region of application, such as for a given LIDAR deployment position and measurement time, or a plurality thereof which may optionally indicate the variation of such parameters at one or more position along a LIDAR measurement beam.

A scalar quantity which may vary as a function of some other parameters may be considered as a scalar field. For example a quantity q may vary as a function of parameters p1, p2, p3, . . . , pM and we may write that s=s(p1, p2, p3, . . . , pM) is a scalar field. Optionally the parameters p1, p2, p3, . . . , pM may indicate position coordinates x,y,z. In that case the scalar field is defined through a region of space, s=s(x,y,z), or through a region of space-time where we account also for dependence on a time parameter t, in which case we may write s=s(x,y,z,t).

A vector is a collection of scalar quantities. For example a vector v may contain a number N of scalar quantities s1, s2, . . . , sN and we may write v=[s1, s2, . . . , sN]. Each scalar component of a vector v may be a scalar field when its components are considered to depend on parameters such as si=si(p1, p2, p3, . . . , pM). Then we may say that the vector v in turn depends on parameters and that we may consider this dependence to constitute a vector field v(p1, p2, p3, . . . , pM)=[s1(p1, p2, p3, . . . , pM), s2(p1, p2, p3, . . . , pM), sN(p1, p2, p3, . . . , pM)]. Optionally the parameters (p1, p2, p3, . . . , pM) may indicate position coordinates (x,y,z), or space-time coordinates (x,y,z,t). In that case the vector field is defined through a region of space v(x,y,z)=[s1(x,y,z), s2(x,y,z), . . . , sN(x,y,z)], or space-time v(x,y,z,t)=[s1(x,y,z,t), s2(x,y,z,t), . . . , sN(x,y,z,t)].

Apart from a LIDAR measurement itself being subject to parameters of the medium in which it is measuring, it is noted that the performance of fluid driven turbines are most definitely affected by the properties of the fluid. A wind speed at high altitude above sea level where the air is less dense carries less mass per unit volume than at close to sea level where air is more dense, and therefore less kinetic energy per cylinder of circular size equal to a given wind turbine rotor and with length equal to the distance travelled per unit of time for the wind speed in question. This is the classical simplified visualisation of how much kinetic energy passes through a wind turbine rotor per unit of time (an indication of the power available in the wind, from which the wind turbine may harvest what it can). Molecular content or humidity may also affect aerodynamic performance. Therefore turbine controllers may benefit by better accounting for the properties of a fluid in which the turbine is operating or planned to operate within. Firstly this may be done in a static sense to account for the generalised fluidic conditions for a given turbine or turbine site. Optionally this data may be dynamically updated on a sporadic or occasional basis, or on a regular or frequent basis.

It is noted that spectral frequency analysis of the LIDAR data itself, or potentially an accompanying source of spectral data, may offer signatures to indicate the molecular composition or other properties of the measurement medium.

It is noted that a LIDAR measurement spectral analysis may provide a Doppler shift in a LIDAR reference frequency which is indicative of the line of sight velocity of molecules or particles moving within a fluid. It is known that the molecular motion is diverse due to thermal motion combined with the general motion, which diversity results in a broad spectral peak. A narrower peak may be obtained from particulates or aerosols suspended in the fluid which are not affected by thermal motion to the extent of much smaller molecules. Both types of peak may be discriminated within signal processing in order to find the Doppler shift of the peak centre frequency.

A Doppler peak spectral width for a Doppler measurement along a given line of sight may provide an indication of turbulent variation of the velocity variation along the line of sight. However, the equipment through which this is measured will act as a filter for some turbulence length scales. Nevertheless this turbulence indicator may be useful. The temporal variation of successive samples measured along a given line of sight can also be used as an indicator of turbulence along that line of sight. However, a single line of sight only provides a one-dimensional measure of turbulence or line of sight wind speed variation.

One may observe and appreciate significant spatial variation in the wind velocity by watching snow falling under a street lamp in blustery wind, or by watching the motion of a large tree in the presence of strong winds, or by witnessing the billowing sail of a yacht. Wind velocity is a vector of three-dimensions. Since wind velocity varies through spatial and temporal dimensions it may be considered as a vector field throughout a region of space-time.

In order to measure the wind velocity there is a simple solution. One can deliberately converge three different Doppler LIDAR beams to the chosen measurement point and collect three respective Doppler velocity components from the same point in space. Provided that the three lines of sight are non-coplanar, and non-colinear then it is a simple matter of mathematics, based on the three azimuth and three elevation angles of the respective three LIDAR beams, to reconstruct the three-dimensional wind velocity, a 3-vector v, from the three different Doppler measurements, a 3-vector w. We may construct a 3×3 matrix M from three rows of three components which are respectively the three unit vectors along the three Doppler LIDAR beam lines of sight. Since each Doppler velocity measurement is the scalar product of its unit vector line of sight with the wind velocity itself (to observe the line of sight component of that wind velocity) then we may write w=M·v and we may reconstruct a wind velocity vector v by taking the vector w of 3 such Doppler measurements and multiplying the inverse matrix of M, denote by (M⁻¹), so v=(M⁻¹)·w. Provided that the scalar triple product of the three aforementioned unit vectors is non-zero then we certainly can calculate the inverse matrix of M.

Naturally a real measurement system has sources of measurement error. It is understood that three Doppler measurement ranges may be subject to small errors in range control. It is understood that a pulsed LIDAR has a finite pulse length and data collected within a timing gate is subject to include reflections from an extended range along the laser beam. It is recognised that a CW range focused LIDAR will integrate its signal over a focus range. It is recognised that a laser has a beam width. It is recognised that angular errors will be present in a real system, thanks to misalignment in calibration, and thanks to finite tolerance of beam steering motorisation systems. The measurement scientist will work to minimise sources of uncertainty. The data scientist will accept that all measurements are subject to sources of uncertainty.

It is noted that all of these sources of error may be present in diverging beam LIDAR designs. The important difference in converging beam LIDAR designs, as compared with diverging beam LIDAR designs, is that the design approach is to collect different Doppler velocity components from the same point in space-time whereas the design approach of diverging beam LIDARs is to collect different Doppler components from different points in space-time. Therefore there is additional measurement uncertainty in trying to measure wind velocity via a diverging beam approach since the velocity vector field itself may vary between the sampling positions, whereas in the case of converging beam LIDAR all lines of sight make Doppler measurements at the same chosen sampling position.

It is noted that a model-based approach is possible where a wind variation model is applied and a set of line of sight LIDAR measurements from different points in space (and time) may be combined with a regression model such as least squares or similar in order to best fit wind parameters according to the model. This approach remains clearly subject to ambiguity since it would give the same result for a set of totally different velocities at the measurement positions, provided that those velocities have the same line of sight component.

A model-based approach may not adequately parametrise the wind variation. For instance one approach is to apply a linear wind shear model with parallel flow. Clearly this ignores the potential for wind veer.

Therefore to avoid ambiguity one may choose to employ converging beam LIDAR for direct measurement of the three-dimensional wind velocity vector. Therefore, in one embodiment three-dimensional wind velocity data is provided by converging beam LIDAR in order to calculate, adjust or constrain at least one parameter of the turbine. This is of industrial benefit since it allows improvement of the turbine with respect to complex three-dimensional flow such as found in hilly regions.

A single three-dimensional measurement can be beneficial. For example a single three-dimensional measurement provides indication of flow inclination angle with respect to the horizontal plane. This is especially noteworthy because Horizontal Axis Wind Turbine design is usually based on horizontal wind flow. Substantially horizontal wind flow is commonly found in rather flat geographies such as Denmark, Holland and northern Germany where much of the modern wind industry has evolved. However, in hilly parts of Scotland and many other areas wind turbines are being operated subject to significant flow inclination angles. This implies that a horizontal wind measurement does not fully reflect the full wind speed that is available to the turbine. This also implies that a wind turbine control methodology that works to capture only the power of horizontal wind flow may harvest less energy than one which is able to capture more of the overall wind flow. Alternatively a wind turbine control methodology, and its parameters, which is optimised for horizontal flow may be sub-optimal in case of non-horizontal flow.

Wind measurement at a single point in space can also be beneficial in quantifying the turbulence intensity condition at that point. Turbulence intensity may be defined as the standard deviation of wind speed divided by the average wind speed during a given time period such as but not limited to 10-minutes. The turbulence intensity statistic may be averaged for a specific wind speed range such as for, but not limited to, 10-minute intervals where the average wind speed is 15 m/s±0.5 m/s.

Turbulence intensity is of specific importance since wind turbine deployment criteria demand correct turbulence intensity measurement in order to select, for a given site with given site conditions, a turbine of an appropriate category. Strength parameters for the tower, foundation or indeed any turbine component or sub-component may be selected depending on the local wind conditions. In principle any wind characteristic may be used for turbine classification, including but not limited to gust statistics, or flow inclination angle.

It is noted that turbulence intensity is a scalar quantity, often expressed as a percentage variation of scalar wind speed (or horizontal wind speed), whereas turbulent variation of wind velocity is a three-dimensional effect. Three beams arranged to converge to a point so as to measure three-dimensional wind velocity at that point may also provide a time series of three-dimensional velocity measurements at a given point, which may be used to indicate three-dimensional turbulence. Also, if one uses the spectral width of the three line of sight wind speed components then one may transform the three spectral widths to indicate a three-dimensional turbulent spectrum. As with three-dimensional velocity, reconstruction of a three-dimensional turbulence measure benefits from deliberately converging three beams to a given measurement point in space and time. If one aims to reconstruct three-dimensional turbulence from diverging beams, such as but not limited to around a large circle swept out by a conical scan, then one is subject to severe ambiguity and error. Even though turbulence intensity is a one-dimensional scalar quantity it is formed from samples of a three-dimensional quantity, namely samples of the horizontal magnitude formed from only the horizontal components of the three-dimensional wind velocity. Therefore reconstruction of one-dimensional turbulence intensity is generally ambiguous for diverging beam LIDARs such as conical scan LIDARs, in the same way that reconstruction of one-dimensional horizontal wind speed is generally ambiguous.

It must be noted that single point measurements are insufficient in order to characterise the variation of the wind across an extended rotor area. The wind industry has traditionally been interested in the vertical variation of wind such as (vertical) wind shear, the variation in wind speed with height, and (vertical) wind veer, the variation in wind direction with height. Therefore the wind industry has traditionally used vertical meteorological masts (also referred to as “met masts”) with instruments mounted at a number of different heights.

It is noted that multiple converging beam triple LIDARs may be arranged to measure wind velocity at multiple points in space. It is also noted that a single triple LIDAR incorporating beam steering may successively and cooperatively steer its three beams to measure at multiple points successively. Therefore a beam steering triple LIDAR may repeatedly gather data from a series of positions to represent one or many virtual met masts. As well as adjusting beam steering angles it may be necessary to adjust the respective measurement ranges for each of the three LIDARs in order to account for varying LIDAR line of sight distance to the measurement points.

More generally than measurement at multiple points in space is the measurement at multiple points in space-time. This may arise from measurement at a single point in space but at a plurality of points in time, or at a plurality of points in space at a single point in time, or at a plurality of points in space at a corresponding plurality of points in time. If position (x,y,z) is within three-dimensional space and time t is one-dimensional then a point in space-time may be specified by a four-dimensional vector (x,y,z,t), which may be referred to as a 4-vector. It is contemplated by some that space-time may be of higher dimension than four. To this extent it is contemplated that space-time may be of any number of dimensions and that the present invention could be applied to one or more measurement points throughout space-time of any dimension.

The wind farm planning and investment process often employs data from a single met mast or a small number of met masts to characterise wind conditions for a much larger number of surrounding turbine locations. Computer models, optionally used within the planning process, may aim to quantify a “horizontal extrapolation” uncertainty but such models often have difficulty coping with complex terrain. Therefore it is noted that a beam scanning, or beam steering triple LIDAR may simultaneously collect data directly from many potential turbine locations, provided there is a clear line of sight. Also it is possible to collect data for nearby alternative locations in order to assess whether the corresponding wind conditions are more or less favourable than the default measurement location. In this way it is possible to improve the “micro-siting” of turbines within an overall wind farm layout. In other words one may fine tune the position coordinates of the turbines. Other parameters may also be fine tuned, such as top tip height, rotor diameter and hub height.

It has been contemplated by many in the wind industry that a rotor-averaged wind speed, or a rotor-equivalent wind speed may be more relevant to the wind turbine than a single point wind speed such as but not limited to that measured by a nacelle mounted instrument. Even in flat terrain the wind speed is generally increasing with height and this variation may be described as wind shear and quantified by various methods such as defining wind shear alpha, a, according to (v2/v1)=(h2/h1)\hat{ }a which indicates the variation of wind speed from v1 to v2 as one varies in height from h1 to h2. Therefore one view of rotor averaged wind speed is to split the rotor into a plurality of horizontal bands spanning a rotor area and corresponding to a plurality of wind speed values within each of a plurality of band centres and to form a weighted average of the plurality of wind speed values with weightings derived from the rotor area covered by each of the respective horizontal bands. It will be appreciated that there are different possible weighting methodologies, in order to arrive at a rotor averaged wind speed, or indeed a rotor averaged wind direction, or indeed a rotor average of any other statistic which varies across the rotor area. Some in the wind industry may use the expressions rotor-averaged and rotor-equivalent interchangeably. However, some others may draw a distinction. For instance some may infer a “rotor equivalent” wind speed from the torque experienced by the rotor, according to blade aerodynamics including blade pitch angle and other parameters. Similarly one may consider rotor averaged wind direction and rotor equivalent wind direction, or rotor averaged wind velocity, or rotor equivalent wind velocity.

In general one may calculate a rotor averaged or rotor equivalent value of any statistic, including but not limited to flow inclination angle, or a general flow misalignment angle with respect to the rotor axis, or with regard to the overall rotor shape. One may calculate a rotor equivalent or rotor averaged value by integration along each blade length, so as to account for changing aerodynamic angle of attack and relative airspeed along each blade. One may also integrate over one or more revolution of rotor revolution since each blade will experience changing wind conditions per rotor angle.

One may consider a turbine to be aligned with fluid flow when the fluid flow is parallel to the turbine rotor axis of rotation. If there is an angle between the rotor axis and the fluid flow direction then one may consider this angle as a misalignment angle. In this case the component of fluid velocity parallel to the turbine rotor axis will be the magnitude of the actual fluid velocity multiplied by the cosine of the misalignment angle.

An aerodynamic misalignment angle may vary cyclically with the rotor rotation angle for a given blade section or blade element. Whenever a misalignment angle is discussed as a function of rotor angle it should be noted that the optional addition, to the rotor angle, of an offset phase angle is also contemplated, including the possibility that such an offset phase angle is any real numeric value, optionally a negative real value. An offset phase angle may be employed in order to allow for a passage of time during which time the rotor blades will rotate onward by a certain angle. For example one or more wind measurements may be made at a given distance in front of the turbine rotor and a wind speed may be employed in order to estimate the passage of time (a distance divided by a speed) before the measured wind reaches the turbine rotor. The offset phase angle magnitude will be the same time multiplied by the rotor angular speed. In case the rotor angular speed is not constant then the offset phase angle will be the integral of the rotor angular speed during the relevant time interval. Furthermore it could be possible to account in a similar way for a data processing or computation time, or an actuation time such as the time taken for a pitch angle motorisation system to rotate a blade from a starting value to a desired value (or set point) of pitch angle parameter.

It is sometimes discussed that one may consider a wind turbine itself as a large anemometer. Therefore it is possible to ignore the fine detail of the actual wind velocity field and to focus on the behaviour of the rotor according to a model of the rotor behaviour. However, this approach may be subject to errors when the model of the rotor behaviour incorporates wrong assumptions. For instance, if the model of rotor behaviour assumes that the the wind flow is horizontal then an inferred rotor equivalent wind speed may be incorrect under circumstances when the turbine is subject to non-horizontal flow. Or if a model assumes that wind flow is parallel in three-dimensional direction across the whole rotor then an inferred wind speed or wind direction or wind velocity may be incorrect. This means that control decisions based on this model may be sub-optimal. This may affect model based LIDAR assisted control, or model predictive control, open loop control and closed loop control. This does not preclude one from attempting to apply such a model but it simply means that doing so is subject to errors. The errors are likely to get bigger especially when the flow is more complex.

It is noted that a wind turbine of a given rotor diameter and situated at a particular (northing, easting) position in a fixed landscape (fixed ground height above sea level) with fixed tower height may rotate or yaw its nacelle direction around a vertical axis so as to aim the rotor toward any horizontal wind direction. In doing so the rotor will sweep out a shape which is approximately spherical or ellipsoid. Therefore, during planning, it can be possible to make measurements at multiple points within the ellipsoid in order to characterise the wind across the whole rotor, or a rotor averaged wind speed/direction/velocity which might be experienced by such a turbine when there situated. In particular, prior to wind turbine installation or during wind farm planning, a converging beam LIDAR incorporating beam steering may scan from point to point within an ellipsoid in order to make three-dimensional wind velocity measurements at this plurality of points, so as to understand the wind variation across a rotor including variation in height to account for vertical wind shear and vertical wind veer, but possibly also from left to right across the rotor to account for horizontal wind shear and wind veer. The three-dimensional nature of the converging beam LIDAR measurement allows to account for non-horizontal wind flow. Turbulence intensity, or three-dimensional turbulence measurement may also be made at each of the points allowing for understanding of the variation of turbulence across a rotor. Optionally a model of turbine yaw may be applied with respect to the wind direction measurements, and consequently a model of the overall wind velocity field witnessed by the turbine rotor may be provided, including the turbine rotor alignment and therefore what rotor averaged or rotor equivalent wind conditions might be witnessed by a turbine if it were indeed situated at the given location.

Therefore direct local measurements of the three-dimensional wind flow which eliminate the uncertainty of “horizontal extrapolation” from a remote data reference such as a distant meteorological mast, and measurement of wind variation across a turbine rotor area, allow for more detailed computer modelling of what annual energy production would arise from a turbine at the specific location. In complex terrain where production losses due to complex flow may be substantial such as more than 10% of annual energy then the added cost of deploying converging beam LIDAR at each proposed turbine location may be very easily economically justified, depending on economic parameters such as expected electricity export price.

A fixed beam converging beam LIDAR could be deployed simply to obtain converging beam LIDAR 3d velocity measurement at a given measurement location such as but not limited to the hub height centre of a planned turbine, optionally providing wind parameters such as but not limited to wind velocity, horizontal wind speed, horizontal wind direction, non-horizontal flow inclination angle, turbulence intensity, three-dimensional turbulence.

A beam scanning, beam switching or beam steering converging beam LIDAR could allow a virtual met mast with three-dimensional measurements made at a series of heights on a vertical axis. The same system could allow a plurality of measurements throughout a sphere or ellipsoid centred at a hub height centre location. The same system could also allow for nearby measurements of one or more alternative turbine rotor centre location. This could be for one more more other turbine within the overall wind farm, or as an alternative deployment position for the same planned turbine—in order to determine which deployment location would be more favourable.

It is appreciated that a wind farm of more than one turbine may suffer from wake effects of one turbine on the inflow at another turbine rotor. Therefore whilst one alternative deployment location may be preferable for a first turbine one must consider that the effect on another turbine could be detrimental. Therefore wake models may be applied, or minimum spacing or other constraints may be applied during wind farm layout planning.

Apart from during wind farm planning it is also possible to deploy converging beam LIDAR in front of or nearby an operational turbine in order to measure the inflow at an operational wind turbine. In general, data may be provided (whether from converging beam LIDAR or from another source) to an operational turbine in order to calculate, adjust or constrain one or more parameter of an operational turbine.

This information may be used for engineering root cause analysis or to understand reason for under-performance, perhaps confirming that underperfomance is due to non-horizontal flow inclination, or local wind shear effects, or perhaps confirming that the turbine is under-performing despite the turbulence intensity remaining within the turbine supply agreement, insurance or maintenance warranty constraints, thereby enabling a warranty claim where appropriate. Equally converging beam LIDAR could be deployed by a turbine supplier or maintenance provider to show that the turbine is not operating within contractual constraints. Furthermore such data may be used to partition the operational data into periods when the turbine is operating out of warranty constraints and periods when the turbine is operating within warranty constraints. This could allow new insurance, warranty and maintenance, or turbine supply contract conditions in order to balance risk between supplier and customer in a fair way and a means to settle disputes.

Optionally, converging beam LIDAR measurements may be vetoed within analysis for those data where wind direction would imply that the measurement location could be subject to wakes of a nearby operational or non-operational turbine, or from another structure such as but not limited to a mast. The wind industry already employs methods to establish such exclusion sectors. It is also noted that a converging beam LIDAR may be deployed with a plurality of LIDAR units surrounding an operational turbine and applying beam steering and measurement range control in order to successively measure at a plurality of points surrounding the turbine location in order to ensure that at least one measurement is supplied from an upwind location irrespective of wind direction. Optionally the LIDAR may determine wind direction from its own measurements and automatically adjust the measurement location accordingly. Optionally the LIDAR may ensure that the measurement location is at a given range from the operational turbine, such as but not limited to 2.5 rotor diameters away. Optionally the measurement height could be maintained at the same height above mean sea level, such as but not limited to the hub height with respect to a given cartographic or satellite navigation system geoid such as but not limited to the WGS84 reference. Alternatively measurement heights could be adjusted according to the surrounding terrain shape, or according to the LIDAR measured wind direction, or according to a combination of LIDAR measurement data with local terrain data. In one embodiment a plurality of measurement positions could be at a fixed height above ground level rather than sea level. In another embodiment a plurality of measurement positions could be at a fixed distance normal to a surface, the surface being either planar or non-planar, which surface optionally may be mathematically fit according to an algorithm to match a set of position points, such as but not limited to the terrain surface.

During the planning and investment process computer models or other methods may be used in an effort to improve or optimise a wind farm layout. The models or methods may involve vetoing or constraining the layout area in order to avoid siting of turbines within a certain range of one or more local occupied residence, or to avoid interfering with an archaeological site, or for various other reasons. It is noted that such models and methods could benefit the wind farm investor by excluding turbine micro-siting regions where wind conditions are unfavourable.

A simple veto may be applied to exclude very unfavourable locations, such as those which are likely to cause excessive loads resulting in uneconomic component failures, maintenance costs or early asset death. Alternatively a complex flow losses factor may be calculated per possible turbine location so that a given location is disincentivised with respect to some other locations, although not entirely excluded. For a wind farm project of more than one turbine the need to separate turbines to minimise or lower wake losses may be traded against the productivity of a given set of micro-sites, along with other constraints or parallel objectives.

Apart from visiting a potential turbine micro-site with a measurement instrument such as a met mast or a converging beam LIDAR, or even a diverging beam LIDAR in an attempt to provide data for determining the favourability of a given micro-site for turbine deployment one could also simply use mapping data available for the given micro-site. One may use the terrain slopes approaching a given micro-site from a given direction, as provided or calculated from such data, as a first order proxy for the likely fluid flow inclination from a given fluid flow direction. One might apply a formula or algorithm based on terrain mapping data in order to estimate wind shear or wind veer, or indeed other parameters such as turbulence. Any such formula, algorithm, computer simulation model or prediction may be validated by comparison with direct measurement in the field using a fluid flow measurement instrument such as but not limited to converging beam LIDAR. Therefore, any of these sources of data may be used in order to calculate a parameter of the wind flow, which may in turn be used to calculate a parameter of a wind turbine, whether that be a physical parameter such as a rotor size or recommended micro-site for deployment, or whether that be a control parameter such as a yaw control parameter, or a cyclic blade pitch adjustment parameter.

The distribution of yaw error in an operational turbine may be used to tune the yaw control parameters such as the time duration of rolling averages which may or may not be used, or the extent of the average error allowed before yaw motors act to correct such an error. In complex terrain these parameters may be set according to wind direction or nacelle direction sector.

It will be appreciated that whenever a first parameter is calculated per a second parameter sector or range, then linear or non-linear interpolation or curve fitting methods may be applied in order to provide a continuous curve in the first parameter, varying with the second parameter over one or more parameter sector or range. Alternatively this curve or relationship could be piece-wise continuous. This allows for convenient look up of the first parameter given a value of the second parameter. Without loss of generality the second parameter may be wind direction, or alternatively nacelle direction.

A data set may contain data of any type. In principle data can be any thing such as one or many birds or the perception of a musical note within one's consciousness. Data is not necessarily numeric. However, it is often convenient to consider data as numeric since we have means available, such as computer memory, computer data storage and computer networks which means allow data transmission, data storage, data processing and data transport of large quantities of numbers in a binary digital format. Data may be analogue. Analogue data signals may be processed by the human ear, or by valves within analogue electronics. Analogue-to-digital convertors aim to represent an analogue signal in a digital format, albeit imperfectly according to its analogue range of application and its number of binary bits available to sub-divide the analogue range. Binary data is stored in number base two, similar to a series of two-way switches on or off. However, a switch may alternatively be a three-way switch, or an N-way switch where N is any natural number. Therefore one may consider data storage in a trinary base-three format, or indeed in any number base such as but not limited to hexadecimal in base-16. A physical book contains data which may be textual or graphical. A finite set of letters within an alphabet may easily be substituted by numbers. However, calligraphy contains artistic analogue data which is beyond simply letters. A picture such as an oil painting may be digitised through a digital photo or as a traditional analogue photo. However, neither photo data, whether analogue photo or digital photo, contains or replicates every detail of the oil painting including texture or sheen when viewed from different angles. Numbers can be contemplated which cannot be stored perfectly in a finite digital format because they would go on forever, whereas a practical analogue-digital convertor is finite. The present invention describes the provision of data, and it also describes the parameters of a turbine. It is contemplated that such data and parameters may be of any possible data type.

One may devise computer models of physical systems, aiming to describe them numerically or logically within a data set. A traffic light signal may be described in a simple computer model as a trinary case of red, amber or green but this is not sufficient to fully describe whether the traffic light is obscured by severe ice and snow. One may add a fourth logical parameter to a computer model—TRUE or FALSE that traffic light is covered in snow and ice. Therefore adding further parameters allows for a computer model to better describe as many as possible aspects of a physical system but this does not guarantee that the computer model author has accounted for all possible parameters in the physical system. Therefore computer models, or indeed theoretical models, can only be an approximate and simplified picture of a real system.

It is noted that a single three-dimensional velocity constitutes a vector and it is noted that one or more velocity vectors may constitute one or more samples of a velocity field. A fluid has a velocity at any point within the fluid and therefore one may consider that a fluid velocity field exists continuously throughout the fluid. We may consider each component of a velocity vector [vx,vy,vz] to be a function of position vector [x,y,z] so the overall velocity vector is a function of position such that [vx,vy,vz]=[vx(x,y,z),vy(x,y,z),vz(x,y,z)].

The wind industry may use computer models of wind flow across a piece of land in an attempt to improve or optimise the layout and micro-siting of turbines of a wind farm planned for the piece of land. The computer model may be quite advanced in terms of computational fluid dynamics, employing excellent calculations for how the wind will flow across the piece of land, based on many data parameters including high resolution terrain map data. A computer model may or may not account for the three-dimensional variation of three-dimensional flow across a large wind turbine rotor. A computer model may or may not account for the wind turbine pitch control in calculating the aerodynamic consequence of that flow across the rotor area. A Blade Element Momentum theory computer model may employ a detailed representation of the wind turbine blade shape, including the changing chord length, shape and twist angle of the air-foil profile chord as a function of range along the blade. Interpolation may be applied using a fine grid between parameter settings and the aerodynamic lift and drag forces may be integrated along each turbine blade. Mechanical and material properties of turbine components such as foundation, tower, drive train shafts, rotor hub and blades may be calculated to account for bending and torsional motions in the structure. A wind turbine sensor model may be incorporated to simulate what signals might be produced by available sensors under given conditions. A wind turbine control model may be incorporated to account for many aspects of wind turbine control such as under what conditions and sensor measurements will the turbine be controlled to yaw left, and what rolling averages might be employed and so forth. Loads at various points within the turbine may be calculated in the model in order to predict how the turbine responds to gusts or turbulence as described within the model. It is therefore understood that the wind flow over complex or simple terrain is very complicated, and that a wind turbine structure is very complicated, and that a wind turbine control system may be of many different types of design as well as having infinite possible parameter settings, and that the aerodynamic interaction with a wind turbine and its rotor is very complicated, and that accurate computer modelling of every detail of a wind farm throughout its lifetime in all weather and maintenance conditions is almost impossible.

In a complex real system of so many parameters the true behaviour cannot practically be replicated within a computer model. We may consider computer models as sanity checks, spot checks or viability checks but they cannot be considered as a true representation of a complex real system.

However, computer modelling does offer some benefit in investment planning. Computer models provide a prediction of wind farm output which is successfully used in wind farm planning. This works, on average, not because of considering the second or third order detail but by considering the bulk average first order effects and making an assessment of the uncertainty contributions, whether from turbulence intensity or wakes and so on. This process can benefit from experience and study of the model prediction success in different environments. When the addition of detail to a computer model results in a better description of reality without an undue computational cost then this is worthwhile but modelling of some detail may have diminishing returns or benefit. Validation of computer models is of fundamental importance since we can only have confidence in a computer model when we see evidence that it reflects reality. Validation of computer models may be achieved by comparison with direct measurements. Validation of three-dimensional flow models may be achieved by comparison with direct three-dimensional flow measurements. Validation of the effectiveness of control systems designed to handle three-dimensional flow effects may be achieved by direct three-dimensional flow measurements combined with logging of control system effectiveness. Control system effectiveness may relate to the power curve and energy production, or to fatigue loads, or extreme loads, or other objectives such as but not limited to noise reduction, power quality. Control system effectiveness may relate to multiple objectives.

It must be noted that computer modelling frequently suffers from wrong assumptions. One form of wrong assumption might be to neglect an important parameter altogether. For instance, if the wind flow across the entire rotor is assumed to be horizontal then vertical flow components would be ignored along with any possibility that vertical flow components may influence the system, which is a source of error when they do influence the system. Or if various load cases are considered but other important ones are ignored then this might not fully reflect the loading and therefore the likelihood of excessive maintenance requirement and early asset death. For example, if load cases are calculated for cases involving horizontal flow but the real turbine is experiencing frequent significant non-horizontal flow then the simulations may be not representative of reality. Or if one aims to model the effectiveness of control systems but neglects control system functionality which responds in a certain way to varying flow inclination to the horizontal then one does not appreciate what gains could be offered by a control system which responds to varying flow inclination in that way, and a corresponding assessment of the effectiveness of control systems will be incomplete.

Computer models which predict wind conditions at a given location may be validated by a converging beam LIDAR. This offers validation of the three-dimensional velocity data distribution at the given location, including flow inclination angle data. A converging beam LIDAR system measuring at a plurality of measurement points with the same lateral position but with different heights offers the possibility of simultaneous unambiguous measurement of a vector of quantities such as wind shear, wind veer, flow inclination, three-dimensional wind velocity, three-dimensional turbulence and other wind attributes whereas a diverging beam LIDAR cannot offer this without ambiguity due to combining samples from different points in space.

Three-dimensional flow models, including computational fluid dynamics (CFD) models, may benefit from validation against, combination with, or input from, three-dimensional flow measurement data, such as but not limited to that provided by converging beam LIDAR. Such models may in turn produce parameters which are used for a purpose, such as but not limited to turbine farm planning improvement purpose, or an operational improvement purpose. Therefore such models maybe used in order to calculate, adjust or constrain at least one parameter of a turbine, whether in operation or in planning.

Furthermore computer simulations may not account for possible improvements offered by alternative control systems or control system adjustments. For instance computer simulations may be based upon an assumption of a cyclic pitch control which is parametrised according to a standard wind shear in horizontal terrain, whereas this provides no information on what increased annual energy production and increased asset lifetime or reduced maintenance costs may be offered by a cyclic pitch control which is better parametrised to account for local conditions, such as but not limited to flow inclination. On the other hand, making use of various data allows a computer simulation to account for improvements offered by alternative control systems, or offered by the activation of existing but otherwise redundant control system functionality. This in turn allows such computer simulations optionally to calculate the value and to quantify the advantage of doing so.

Furthermore a control system may be designed to account for complex flow parameters such as but not limited to non-horizontal flow inclination, but if that control system is not provided with the required data to account for a given deployment conditions then the control system is not being allowed to perform to its full capability. For instance, a cyclic pitch controller might be installed with parameter options allowing for flow inclination, or for wind shear or other specific flow characteristics, maybe to account only for the rotor tilt axis, or maybe also to account for varying slopes per wind direction sector, but if the data corresponding to the specific deployment location is not provided as input then this functionality may be rendered useless. Perhaps the turbine controller will be running with default parameters in this regard, possibly defaulting to handle the case of horizontal flow. Or maybe worse still, the turbine controller might be set up with parameters copied from a previous deployment, perhaps incorrectly believed to be analogous, or perhaps without due care, in which case a cyclic pitch controller might be trying to correct for the wrong conditions entirely. A cyclic pitch controller is just an example and clearly this discussion applies to the correct provision of input parameters to any type of controller. Correct input parameters may be dependent on the deployment locality or position, such as local air density, directional forestry features, local structures or directional terrain features. But correct input parameters may also depend on other factors such as but not limited to turbine model, rotor size or tower height. Data and parameters may be static, such as but not limited to turbine dimensions, or dynamically varying with time, or with seasonal temperatures and icing, or with wind direction which may change within a few seconds.

Fluid flow measurement instruments, including LIDAR, including converging beam LIDAR, can provide data concerning fluid conditions, including but not limited to fluid flow conditions, including but not limited to fluid velocity. This data may be provided as input to simple and/or advanced controllers, including but not limited to turbine controllers, including but not limited to yaw controllers or blade pitch controllers, including but not limited to collective blade pitch controllers or individual blade pitch controllers, or independent blade pitch controllers, which may be cyclic or non-cyclic blade pitch controllers, which may or may not be sinusoidally cyclic blade pitch controllers.

It is contemplated that any type of controller may be replaced, over-ridden or adjusted by the installation of a retrofit controller. A retrofit controller may piggy back on an existing controller. A retrofit controller may be installed in parallel or in series with an existing controller. One or more input or output of an existing controller may be disconnected from the existing controller and connected instead to a retrofit controller. Alternatively an input or output may not necessarily be disconnected from an existing controller but may be additionally connected to a retrofit or additional controller. It is contemplated that any existing control system on an operational wind turbine may be adjusted in this way. Therefore it is possible to enhance the control system of existing operational turbines throughout the world by installing beneficial retrofit controllers. Of course it is also possible to enhance controllers during the factory manufacture of turbines so that the control functionality of a retrofit controller is included as standard. The possibility of retrofit installers allows for new control improvements to be deployed to wind turbines which have already left the factory and are operational. It is contemplated that in some cases a retrofit controller may benefit or may require further installations, such as but not limited to a converging beam LIDAR, but in many cases benefits may accrue simply from altered logic provision, and/or altered data provision such as but not limited to expected flow inclination per wind direction angle, or an updated wind shear data or corresponding control parameter. A retrofit controller, or a replacement controller installed at the factory, may optionally include many components for making many independent, or dependent, improvements.

It is also contemplated that a retrofit controller may take the form of software or firmware only, eliminating the need to physically install a retrofit unit with physical connections. A software or firmware upgrade is equivalent to altering parameters. Optionally, an upgrade or parameter change may be done remotely through a data transfer using any method of data communications. An instruction set, optionally encoded in any format, or any type of data file may be considered to be a data set or parameter set.

When making any change to an operational wind turbine, such as but not limited to altering an individual operational parameter setting, or upgrading a wind measurement device, or installing a retrofit controller which over-rides at least one aspect of control, then one may estimate the benefit of the change by comparing operational data from before the change with that gathered after the change. It is understood that environmental conditions may not be exactly equal before and after the change. Nevertheless, provided that a reasonably representative set of data is gathered before and after the change then one may make a reasonable estimate.

More broadly one may consider that this process is equivalent to partitioning an overall data set into one partition in a time period before the change, and another partition in a time period after the change. It is noted that operational data may be compared between data partitions with regard to any parameter, not just time. For instance one may partition a data set according to, but not limited to, wind direction (or nacelle yaw angle). In order to ensure that sufficiently representative data is gathered then one could require a significant time duration in the context of the turbine lifetime, such as one year of data. Alternatively one may argue that the main parameters governing performance might be wind speed and wind direction, and that all else being equal one may simply require a certain minimum number of data samples, such as but not limited to 10-minute data averages, or alternatively using high rate data such as 1-second samples, to be gathered throughout the main operating parameter range, or bins/partitions thereof. For example one may form average power performance curves by splitting the wind speed regime into 25 bins of wind speed v where J<v<=J+1 metres per second, with J taking 25 integer values from 0 to 24 inclusive, and where v is a real value. Furthermore one may partition these data sets according to wind direction d split into 12 bins of wind direction angle spanning 0-360 degrees such that D<d/30<=D+1. In this example one has 12×25=300 bins or data partitions and one may apply a required number of data points within some or all of those bins in order to ensure that a representative set of wind conditions are sampled. Of course one is free to employ any parameters of choice for such data-partitioning, and one is free to employ data-partitioning in any number of parameter dimensions, and any extent of data partitions—they need not be equal in extent, especially if the operating regime does not frequently enter a given range. For example, one might choose to ignore bins of wind speeds greater than 15 m/s if a given turbine does not usually operate under these conditions. Or one may increase the bin widths in that range such as employing three bins between 15 and 25 m/s, such as 15<v<=17, 17<v<=20, and 20<v<=25 (m/s) respectively. One may also require a minimum percentage of the overall data set, or a minimum number of data points, within each data partition and one may specifically define the partition ranges in order to achieve this. For example an algorithm can easily determine a maximum value of v20 where 5% of the dataset are included within the partition v20<=v<=25 (m/s). Then one could determine a value v19 where exactly 5% of the dataset are included within the partition v19<=v<v20 (m/s), etc, such that the lowest 5% of the data are within the range v1<=v<v2 (m/s). This is just an example where 20 bins are employed. Clearly other partitioning schemes, may be defined with a similar approach but with different bin population requirements and number of bins.

When comparing before and after a given event, such as a control upgrade event, one must clearly consider whether there are other known reasons which would render the periods not reasonably comparable. For example, if a control system software upgrade occurred during one of the comparison periods then this might be reason to invalidate the comparison. Or if the wind turbine was known to have suffered a lightning strike resulting in minor damage to one of the blades, then this could be reason to doubt the comparison. Also, one may potentially be unaware of a significant event which renders a comparison invalid. For this reason it may be particularly useful to check repeatability of the comparison. If one makes a comparison of power curve performance for one angular range of wind direction compared to another, then one may repeat such an analysis for an entirely different time period of data. If differences are repeatable comparing one partition to another then one may gain confidence that the observed difference between the two regimes is real and repeatable. In case of a retrofit control system it can be possible for the retrofit control system to operate in a benign mode, or by-pass mode. For such a system applied in series, for example when applying a blade pitch adjustment on an existing blade pitch signal, then by-pass mode may be achieved by setting the blade pitch adjustment to zero. This then allows to revert, if required, to the original control system. Therefore one may, as desired, switch between periods employing a new control method and periods employing an original control method. One may log the difference and observe improvements in power curve performance, or overall energy production, or reduction in loads or vibrations as measured by condition monitoring sensors. Therefore one may repeatably assess the improvement, or indeed any degradation, comparing different parameters or methods. A system maybe programmed to switch repeatably between one or more modes, to gather an amount of data, and optionally to automatically compare a performance parameter between the one or more modes, and optionally to report the change in performance parameter between one or more modes. Optionally the change in performance parameter may be evaluated in terms of energy production and therefore revenue value. This may offer a means for the wind turbine operator or owner to confidently assess whether a given change should be implemented in the long term. This may also offer a means to define a royalty payment to the supplier of a retrofit control system based on the revenue value of control upgrade.

Apart from change of control parameters applied via physical installation of a retrofit controller, it is possible to define a revenue benefit (itself a parameter) with reference to one energy production compared to another energy production, such as an energy production calculated from one power curve, as compared with that from a second power curve by multiplication with a wind speed distribution (which should be representative of the operating regime). For example, if wind shear alpha is an optional data input parameter of an existing control system then it could be possible to measure local wind shear alpha using a measurement device in order to evaluate through measurement what parameter setting is appropriate for the given application. A performance change due to the new versus the default parameter settings may be evaluated in terms of increased wind turbine revenue. It will be appreciated that the power curve relationship between average power and average wind speed is just one possible operating characteristic. Alternative characteristics, of any number of dimensions, may be applied to calculate an energy production.

Apart from wind flow parameters such as wind shear, wind veer or flow inclination (generally varying per wind direction) there are many aspects of wind turbine rotor geometry (usually not varying per wind direction) which contribute cyclically to the aerodynamic angle of attack and relative wind speed to any given element of any given blade as it cycles repetitively round the rotor under steady state wind conditions. Geometric parameters may include (i) rotor axis tilt angle, (ii) a blade shape parameter, (iii) a rotor pre-cone geometric parameter, and/or (iv) a smart rotor adjustable geometry parameter. Subject to blade bending, twisting and flexing, and oscillations thereof, we may consider that for a given angle of the blade around its rotor rotation then, excluding the case of deliberately changing blade shape parameters for a “smart rotor”, all blade elements along the length of the blade are expected to be in a fixed orientation for a given blade pitch angle which means that the integrated lift and drag forces resulting from all blade elements along the length of the blade, each having its own aerodynamic angle of attack and relative wind speed under steady state wind conditions, should be the repeated every time the blade reaches the given angle in rotor rotation, and therefore the overall blade forces are predominantly cyclic.

However, the wind is not always in a perfectly steady state. Also, bending, twisting and flexing of the entire turbine structure exists along with oscillations thereof including tower, rotor axis, hub and blades. Blade pitch may be changing non-cyclically. Resonances may occur. Resonances may also be damped through passive and active control measures. Therefore, it is appreciated that the true picture is more complicated than a simple cyclic behaviour. Nevertheless the simple cyclic behaviour may dominate on average and therefore cyclic controllers may be beneficial to account for the wind parameters as well as geometric parameters which contribute cyclic loading.

The possibility of adjusting a control parameter such as but not limited to a cyclic pitch adjustment parameter according to another parameter such as wind direction (or alternatively nacelle yaw angle) has been discussed. It will be understood that the aerodynamic angle of attack and relative air speed at a blade element is also sensitive to the absolute three-dimensional wind velocity which varies around the rotor according to parameters including but not limited to the wind shear. Therefore it is noted that it may be beneficial to adjust a control parameter such as but not limited to a cyclic pitch adjustment parameter according to more than one operational or environmental parameter, such as but not limited to a first parameter being wind direction (or alternatively nacelle yaw direction) and a second parameter being a wind speed parameter (such as but not limited to that measured measured by a nacelle instrument, or alternatively by a LIDAR system, or a derived rotor average wind speed). In general a parameter, including a control parameter, including a cyclic blade pitch control parameter, may be adjusted according to any number of data parameters. This may be done via look up table, or functional calculation.

Without limitation a cyclic function parameter may be an angular offset with respect to a rotor angle reference, an amplitude (including a sinusoidal or non-sinusoidal amplitude), or a bias offset (non-cyclic component). A cyclic function may be composed of a sum or product of other cyclic functions, each with its own cyclic function parameters. A cyclic function may be an infinite or finite-truncated Fourier series of sinusoidal functions. A non-cyclic bias or offset may be a static constant, or may be derived dynamically from operational, environmental or other parameters.

It is noted that a system to provide data in order to calculate, adjust or constrain at least one parameter of a turbine is equivalent to a system to provide data in order to calculate, adjust or constrain at least one parameter of a vehicle. Therefore all systems here discussed for application to a turbine may alternatively be applied to a vehicle. This may be achieved by substituting the word “turbine” by “vehicle”. Such substitution of words, and therefore of concepts contemplated or inventions claimed, may be undertaken with regard to methods as well as for systems Similarly computers, programs or instruction sets for providing a turbine in accordance with an invention claim for a turbine may be substituted by computers, programs or instructions sets for providing a vehicle in accordance with an invention claim for a vehicle.

Wind measurement instruments, including LIDAR, including converging beam LIDAR, can provide data concerning fluid conditions, including but not limited to fluid flow conditions, including but not limited to fluid velocity. This data may also be provided to vehicles such as but not limited to helicopters or other rotor driven craft including drones, dual rotor helicopters, quad-copters, counter rotating rotor craft, propeller-driven marine craft, propellor-driven submarine craft, impellor-driven craft, semi-submersible craft, and the like. The data, or parameters derived from it, maybe employed within vehicle control systems. In the case of helicopter rotors, or any type of bladed propulsion or navigation unit, the data may be used by blade pitch controllers, including but not limited to collective blade pitch controllers or individual blade pitch controllers, or independent blade pitch controllers, which may be cyclic or non-cyclic blade pitch controllers, which may or may not be sinusoidally cyclic blade pitch controllers.

Geometric parameters of a turbine may be varied in order to better suit the turbine for given environmental or other project conditions. Many wind farm projects limit the top tip height or rotor diameter and tower height parameters for reasons of visual impact with regard to planning conditions. In principle the tilt angle of a turbine rotor axis may be varied to better match the local shear conditions, optionally accounting for one or more other parameter such as a parameter of overall rotor shape, optionally accounting for the general change in rotor shape per fluid flow speed, etc. Any geometric parameter, such as but not limited to rotor axis tilt angle, may be adjusted at the design stage and in factory manufacture in order that a turbine may better suit its intended deployment location. Furthermore a geometric parameter, such as but not limited to rotor axis tilt angle, may be dynamically adjusted during operation of the turbine, provided that the geometric parameter in question is adjustable.

HAWT do not usually have an adjustable rotor axis tilt angle but this may be arranged with a suitable motorisation system similar to that motorisation system typically employed by yaw motor systems but with motorisation around a different (horizontal) axis. More generally motorisation may be undertaken around any axis direction which optionally may suit non-vertical towers situated in sloping terrain, provided with an adequate foundation, and considering the effects of gravity with regard to material stiffness and bending or oscillation, and considering also the cyclic forces due to gravity acting on a rotating rotor. Therefore a turbine rotor axis may include motor control of both the yaw axis and/or the tilt axis. When tilting the rotor axis one must pay attention that this does not cause the rotor blades to collide with the tower. Therefore when providing a turbine with tilt angle motorisation it may be appropriate to provide the tilt angle motorisation with angular limits. It is noted that yaw motorisation systems, although typically allowed to rotate through the full 0-360 of possible horizontal wind directions, will usually incorporate “cable twist” limits such that the yaw angle is constrained to a range such as but not limited to −720 degrees to +720 degrees which is greater than 360 degrees in extent. In principle a tilt angle could be allowed to rotate through more than 360 degrees although in this case the turbine might not be mounted on a conventional vertical tower but on a non-vertical axis frame or a non-vertical tower. In practice it is envisaged that the usual application of tilt angle control might be for vertical tower mounted wind turbines operating in a hilly landscape where they may frequently be exposed to non-horizontal wind flow inclination angle, typically depending on wind direction (or alternatively nacelle direction). Such flow inclinations potentially could be of any steepness up to 90 degrees to the horizontal but in practice are likely to be in a range such as but not limited to between −8 to +8 degrees as already required by some wind farm developers or turbine supply agreements. However, an adjustable rotor axis tilt angle will allow for much greater wind flow angles without the detrimental effects which would be experienced for a turbine without such adjustability. Therefore flow inclination parameter constraint might be set to a wider range such as but not limited to between −30 and +30 degrees for turbines not mounted on a vertical tower, or perhaps between −8 and +30 degrees for turbines mounted on a vertical tower where the −8 degrees corresponds to a limit on pointing the axis downward where the limit is for protecting against collision with the tower.

If vertical flow inclination of −8 degrees is permitted for flow up a slope toward a rotor axis which is tilted upward at 6 degrees then this implies a maximum angular misalignment of 14 degrees in flow direction with respect to the rotor axis. On this basis one might expect the upper bound to be 6 degrees of tilt plus 14 degrees which is 20 degrees implying a flow inclination permitted range of −8 to +20 degrees. This could be useful for a turbine location situated at the edge of a flat plain at the base of a slope of up to 20 degrees since such a turbine might frequently experience wind flowing down the slope at 20 degrees but not frequently experiencing flow inclination angle less than zero degrees. In fact one might say that a typical present day HAWT design with its positive tilt angle (approximately 5 or 6 degrees typically) is suited to positioning within sloping situations where the slope from beneath the turbine is lower, and the slope above the turbine may be steeper. One may say that the converse is also true—that present design of turbine is less suited for sloping situations where the slope below the turbine is steeper than the slope above the turbine. It is noted that wind farm planning process might do better to apply an asymmetric bound on flow inclination angle, and to make note of the expected flow inclination angles from different wind directions, when assessing whether a turbine is suitable for a given deployment location or during tuning or micro-siting of wind farm layouts.

Apart from checking whether a micro-site is permissible with respect to maximum flow inclination to the horizontal, one may also aim to calculate complex flow losses due to flow inclination based on the surrounding slopes at a given turbine micro-site. This may be done as a separate calculation, or as part of wind farm layout planning software. One may use map data such as grid data, or contour data, and/or GPS or other type of terrain survey grid measurements made at the site (including LIDAR terrain survey using hard target LIDAR as opposed to Doppler LIDAR for wind measurement). For example, but without limitation, one may calculate expected flow inclination at a given location per wind direction sector of 30 degrees extent. Other data partitions in wind direction parameter are possible and may be applied, including regular or irregular intervals. Interpolation may be applied between data partitions or wind direction “bin-centres” in order to arrive at an expected flow inclination angle for any wind direction at that location. This data may allow calculation of expected flow angles at a given potential turbine location or micro-site. This may be compared with that for another turbine location or micro-site. This may feed into overall layout planning including other constraints. Instead of estimating flow inclination angles using map data or terrain survey data it is also possible to make direct measurement of flow inclination angles as a function of wind direction, by using a direct measurement device per micro-site location. Without loss of generality such as device could be provided by meteorological instruments mounted on a mast, or by SODAR, or by LIDAR, including the possibility of converging beam LIDAR which has the advantage of converging at least three beams to the measurement point so as to avoid ambiguity in the measurement thanks to spatial variation of the fluid flow. It is noted that whilst deployment of converging beam LIDAR for purpose of measuring flow inclination within very flat terrain may not be economically justified (although there could be other reasons for doing so with regard to turbulence measurement, wind shear and other matters) it is quite likely that there are very many locations where wind turbines are being deployed in very complex terrain to the extent that this is causing losses greater than 10% in annual energy. For large turbines with a 25 year asset lifetime in reasonably windy locations and exporting their electricity at a typical electricity market price this can easily be much greater cost than a survey with converging beam LIDAR. For instance, if a converging beam LIDAR survey per micro-site costs 25 thousand pounds for a turbine site which might generate ten million pounds but suffering 10% losses worth one million pounds then the deployment of converging beam LIDAR is cost effective when it identifies conditions which cause 10% losses such that the wind farm investor may avoid the detrimental micro-site conditions. One approach could be to undertake calculation of estimated flow inclination based on map grid or survey data and then deploy converging beam LIDAR where the flow inclination is found to be approaching a limit, or worst case. Then the converging beam LIDAR may directly measure and confirm this prognosis. Furthermore the converging beam LIDAR or an alternative converging beam LIDAR may measure at many locations in order to determine which are favourable and which are unfavourable. In this way the wind farm owner and investor profits better from their investment and the wind turbine or wind farm asset produces more renewable energy, which may be a desirable thing.

It is noted that Global Positioning System (GPS) is an American example of a satellite navigation or positioning system. In everyday English language “GPS” is often used to mean “global navigation satellite system” (GNSS), or a satellite navigation system which may not necessarily be a global system. Any discussion of GPS or satellite positioning may equally apply to other satellite positioning or navigation systems such as GLONASS (a Russian system), GALILEO (a European system), BeiDou (BDS, a Chinese system), Indian Regional Navigation Satellite System (IRNSS), Quasi Zenith Satellite System (QZSS, a Japanese system), or other systems. A reference to “GPS sensor” or “satellite positioning sensor” or “satellite navigation sensor” may be considered equivalent and may equally apply to any of the aforementioned positioning systems, not limited to GPS. Also a reference to GPS or satellite positioning may refer to an enhanced or augmented satellite navigation system such as differential GPS. It will be appreciated that many different types of enhancement are possible, such as the utilisation of corrections provided by one or more reference ground stations of very well known location, such that variation in measured signal at the one or more reference station may indicate atmospheric corrections which might be generally applied. This allows for varying atmospheric conditions, or ionospheric conditions.

It is well known to those skilled in the art of wind turbines that significant power production losses may occur when a turbine rotor is misaligned with respect to the wind direction. It is expected that, on the rise of the power curve (when the turbine control system aims to maximise power harvested from the wind, and considering that the power in the wind rises cubically with wind speed), the lost power will be proportional to unity minus the cubed cosine of the yaw error. We may consider that power, P=k·v³, where k is a constant of proportionality and v is wind speed (or overall rotor equivalent wind speed). If the turbine experiences misalignment of yaw angle error y then P=k·(v·cos(y))³. Regarding overall energy loss the cubic proportionality does not hold exactly which is not surprising since the turbine is not always operating on the power curve rise. Rather the turbine is sometimes operating in different modes, such as at its rated power (above rated wind speed) when the power is typically constant. Nevertheless it is widely considered that annual energy losses might be approximately proportional to unity minus the square of the cosine of yaw misalignment angle, for instance in case where the yaw control was subject to a constant bias of angle offset y.

It is also known that a yaw misalignment error also gives rise to greater loads throughout the wind turbine structure, including blades, rotor hub, drive train and generator (optionally including gear box), tower and foundation, including all interfaces and bearings throughout the structure. Vibrations may also be exacerbated by yaw error. If one considers a yaw error as a horizontal misalignment angle with the wind direction then one may appreciate that a vertical misalignment may result in similar disadvantages. One may then appreciate that a rotor tilt angle, such as approximately 6 degrees, is causing a vertical angular misalignment of the turbine with respect to a horizontal flow. One may quickly appreciate that when the flow is not horizontal then a vertical flow inclination angle combined with any tilt angle gives rise to a combined vertical misalignment. A flow inclination angle from underneath the rotor adds to the rotor tilt misalignment. A flow inclination angle from above the rotor subtracts the rotor tilt. A vertical and horizontal misalignment are not mutually exclusive and can therefore both apply simultaneously.

It is noted that whilst misalignment angle may vary around the rotor, since flow is not necessarily parallel flow, it may nevertheless be possible to calculate an effective misalignment angle which is indicative of the overall state of misalignment. This may be a weighted average misalignment angle. One may consider a rotor averaged or rotor effective misalignment angle across the entire rotor. Apart from a general misalignment angle one may calculate weighted averages of any wind or fluid parameter such as but not limited to fluid density, air density, a molecular concentration of any given molecule type, turbulence intensity, yaw misalignment, vertical inflow misalignment, wind shear, wind veer, any component of three-dimensional wind velocity in any frame of reference, any component of three-dimensional turbulence in any frame of reference. An overall misalignment angle may result from a combination of misalignment angles from different sources such as but not limited to yaw misalignment combined with vertical flow inclination. Vertical flow inclination, which is the angle of flow with respect to a horizontal plane, may also be referred to as non-horizontal flow inclination, or simply as flow inclination.

It is noted that wind speed may be employed for various start up and shut down control measures. For example at very low wind speeds insufficient for power generation there is no point in yawing the rotor to point into the wind direction which may not be well defined and will waste energy used by constant yawing. Therefore a minimum wind speed for yaw start up may be set. Also at an upper limit of wind speed the turbine may be required to shut down. This may be referred to as storm shut-down wind speed, or high wind shut-down wind speed. Traditionally this was an abrupt threshold but this may also be a more smooth curtailment of output power, which may be considered as a new control mode. After a storm shut-down the turbine may be allowed to re-start once the wind speed has fallen to a lower value. For all of these control measures a wind speed is needed. If the wind speed is measured with an error, such as but not limited to a misalignment error, such as but not limited to a vertical flow inclination misalignment error, then the wrong wind speed may be used by the control system which implies that the control philosophy is contravened. For example, if a turbine control system believes that wind speed is lower than it really is then the turbine may continue to operate in what are considered unsafe or damaging conditions. And if the wind speed is thought to be lower than it really is during start up then the yaw system may not be enabled in good time, meaning that a generation opportunity is lost. Since low wind start up is a very frequent event it can be possible that energy production lost by this mechanism adds up to a substantial energy value over time, even though the power output at lower wind speeds tends to be low. It is noted that a control system may be adjusted, or a retrofit control unit applied, in order to over-ride the wind speed provided by nacelle mounted or other anemometry. Therefore it is possible to multiply or divide (depending on the control application) a wind speed by the cosine of a misalignment angle. It is also possible to alter such an adjustment depending on the value of another parameter, such as but not limited to wind direction (or nacelle yaw angle).

Parameters of rotor geometry such as pre-cone angle and blade shape parameters may be statically or dynamically adjusted in combination with the tilt angle, and/or yaw angle, adjustment, to allow rotor axis control without rotor blade collision with vertical or non-vertical tower or mounting frame. Dynamic adjustment of rotor shape parameters may be referred to as adjustment of “smart rotor” parameters. It is also noted that a rotor centre or hub may be displaced forwards (or backwards considering downwind rotor designs as well as upwind rotor designs) with respect to a rotor yaw motorisation axis and/or a rotor tilt motorisation axis. This displacement may be constant or static, or potentially dynamically adjustable. For instance, without loss of generality, the rotor drive shaft may be telescopic, or the rotor drive system itself may be mounted on a rack and pillion or other type of linear motorisation system.

Apart from computer simulations undertaken at the planning stage, usually aimed at estimating the annual energy production for a wind farm having certain parameters, it is also noted that computer models and look up tables may be encapsulated within operational controllers which incorporate one or more parameter. An operational turbine controller may include a control methodology which works on the logical basis of a possible wrong assumption, such as but not limited to assuming that the wind flow is horizontal.

It should be noted that when we consider a design based on a possible wrong assumption this is equivalent to the designer appreciating that the assumption does not always necessarily hold, but nevertheless assuming that it is is reasonable to work on the basis that the assumption usually holds to the extent that the design need not cater for the assumption being wrong. In other words the consequences of the assumption being wrong are expected to be unimportant, despite knowledge that the assumption does not always hold. A designer of a system may appreciate that the system, such as but not limited to a wind turbine control system, works on the basis of assumptions, such as but not limited to an assumption of horizontal and/or parallel flow, and may be qualitatively aware of one or more failings of the design whilst being unaware of, or not motivated or caring to evaluate the actual quantitative impact of the one or more failing.

A control tracking algorithm may be employed to vary one or more parameters, such as but not limited to blade collective pitch angle and rotor RPM or tip speed ratio, toward maximising another parameter, such as but not limited to power output. However, this maximisation may be undertaken with the assumption that the turbine is operating on a control surface which is well known in at least one feature, which feature is to be exploited by the control system. Problems, such as but not limited to sub-optimal power curves and energy production, or excessive fatigue or extreme loading, may arise when the assumed control surface differs substantially from the actual control surface.

A control system may aim to keep a system operating at a peak value of a first parameter (or objective function) as a function of a second controllable parameter such that when both parameters are increasing then it is considered that the (controllable) second parameter should continue to increase, whilst when the first parameter is decreasing with increase of the second parameter then the system has gone too far, and beyond the optimal peak, such that it is necessary to decrease the second parameter in order to assist restoring the first parameter towards its peak maximum (optimal) value. It is noted that an objective parameter may be a function of more than one parameter, each such parameter being possibly controllable or else not controllable, and each such parameter being possibly measurable (or known) or else not measurable (or not known). It will be appreciated that minimising or maximising an objective function is an equivalent process, taking note of the positive or negative sign of changes in parameters.

In one embodiment a control surface might be maximum power as a functional surface over two dimensions such as (i) collective blade pitch, and (ii) rotor RPM. It could be possible that the control surface is acknowledged to vary based on another parameter again, such as wind speed measured by a nacelle mounted instrument. However, if one parameter is wrongly measured then the actual control surface could differ from the anticipated control surface which could result in sub-optimal tracking on the control surface. It should be clear that this described system is just an example, and that a control surface may employ different parameters as inputs or assumptions. It should also be clear that a control surface is not limited to any given number of dimensions such as an objective function of two parameters, but that a control objective parameter may be a function of any number of parameters, constituting a hyper-dimensional surface. It is also noted that multi-objective parametrisation and control surface constraints may apply.

It is also noted that different modes of control are possible. For instance, in one embodiment a wind turbine transitions between regions 1, 2 and 3 of control describing (i) low wind start up, (ii) rising power with fixed pitch parameter and rising rotor RPM, and (iii) fixed maximum (rated) power and fixed RPM operation respectively. Transitions between the successive operational modes may commonly be described as regions 1.5 and 2.5.

If a control system is in a transition between two modes such that one mode would demand a control signal s1 whereas another mode would demand a control signal s2 then one may transition smoothly between the two modes according to a real number parameter p continuously varying between 0 and 1 such that the resulting transition control signal sT is given by a linear superposition sT=(1−p)·s1+p·s2. Without loss of generality non-linear transitions according to other superpositions may also be implemented. In case of a wind turbine control system where it might be desired to transition from a first mode into a second mode in a linearly smooth way according to wind speed v in the range v1 to v2 then the parameter p may be given as p=v/(v2−v1).

A data set is a collection of data of any type. Data may be parameters. Parameters may be data. A data set may be partitioned or split into partitions. For example a data set may contain wind speed, power data and wind direction data for a series of date-time values. It would be possible to split or partition this data set into two sub-sets or partitions such as a first partition for all data associated with date-times where the wind direction was within ±90 degrees of west or exactly from north, and a second partition for all remaining data. In this example we can logically surmise that the second partition contains all data associated with date-times when the wind direction was within ±90 degrees of east or exactly from south since this is the complement set for the first partition and we know that all data must lie within one of the two partitions. One may consider data within a particular partition to correspond to a particular regime. Different partitioning schemes are possible. Partitions of a particular partitioning scheme do not overlap. However, it is recognised that different partitioning schemes are possible and partitions from different partitioning schemes may overlap or intersect. For example one partitioning scheme with four partitions could be all wind directions within a positive offset angle less than 90 degrees from 0, 90, 180 and 270 degrees, whereas a second partitioning scheme with four partitions might be all wind directions within a positive offset angle less than 90 degrees from 45, 135, 225 and 315 degrees. A data set may contain data or parameters within a domain of possible values. For instance the wind direction may be defined as a numeric value for angle within a domain from zero to any real number value less than 360 degrees from north. Wind direction equal to 37.32 degrees could be a particular data value within the overall domain of wind direction. A domain may be finite or infinite. A domain may be split into a sub-domain. A sub-domain may be of equal or lower dimension than a domain. An overall data set of actual values within an overall domain of possible values may be split into sub-sets or partitions of actual values which are bound by a particular sub-domain of possible values.

Data, of instantaneous values or time-averaged values, may be collected at regular intervals in time, or at irregular intervals of time such as but not limited to the case of event-based logging of errors or status messages from a wind turbine control system where such events or errors may occur at irregular and unpredictable time intervals. Regular intervals in time may be of any duration, such as but not limited to 10-minutes, one minute, five seconds, one second, one hundredth of a second, or one millisecond.

A data set may consist of a set of data scalars or a set of data vectors. For example, without loss of generality, time-stamped wind turbine data may consist of a vector of four scalar values [t,v,p,d] where t is date-time, v is horizontal measured wind speed, p is power and d is wind direction. A two-dimensional “power curve” scatter plot may be plotted for (v,p) pairs extracted from each of the time-stamped data vectors on a graph with abscissa representing v and ordinate value representing p.

Histograms may be formed from a data set by splitting the overall domain into a set of sub-domains and processing the data from within each sub-domain. For example, for a data set where wind speed is within a bound range of 0-25 m/s, a power curve histogram may be formed by partitioning the data into 25 partitions denoted by an integer J from 0 to 24 inclusive such that for each partition the wind speed v satisfies J<=v<(J+1). Referring to the power curve scatter plot example of the previous paragraph we may form a power curve histogram. We may, for each partition J, calculate an average (vJ,pJ) for all (v,p) pairs where J<=v<(J+1). We may choose to evaluate also the standard deviations (svJ,spJ) of v and p within each partition J and plot the resulting graph or histogram of (vJ,pJ) values optionally with error bars denoting the extent of (svJ,spJ). The histogram partitions J are often denoted as “histogram bins”. We may say that a power curve histogram is a bin-averaged power curve as opposed to a power curve scatter plot. Given a data set consisting of data vectors it is possible to partition the data set according to any element of the data vector, such as the first element, or the second element, etc. It is also possible to partition the data, or “bin the data” in more than one dimension of the data. For instance one might firstly partition the data of our example as described according to wind speed v. Secondly one might, for each of the wind speed bins J, subsequently bin the data according to bins K with reference to the value of wind direction d. For example, but without loss of generality, we might form 12 bins in d denoted by integer values of K from 1 to 12 inclusive such that (K-1)<=d/12<K. This would have the effect of binning the wind direction in bins of width 30 degrees where 0<=d<360 degrees. Then one might process the data within each bin similarly in order to produce a histogram indicating the variation of power for each bin of wind speed per bin of wind direction.

One may manually or automatically choose the number of partitions based on data populations. An algorithm may adjust the number of data partitions according to the data populations per bin in order to ensure that a minimum bin population is maintained within one or more bin. An algorithm may adjust the number of bin partitions in order to maintain one or more error bars of percentage error within a maximum threshold within one or more bin. An algorithm may adjust bin boundaries in order to maintain a minimum bin population within one or more bin. An algorithm may adjust bin boundaries in order to maintain error bars or percentage errors per bin less than a threshold for one or more data bin. When making comparisons between two data sets data bins or partitions employed need not necessarily be of equal size or extent for both data sets, although identical bin ranges may be preferred with the aim of comparing like with like.

The phrase “power curve” is sometimes used within the wind industry to refer to a (v,p) scatter plot and sometimes used to refer to a bin-averaged histogram. Optionally the bin-averaged histogram includes only the bin-averaged power value plotted at the wind speed bin-centre. Optionally the bin-averaged histogram includes the bin-averaged power value plotted at the bin-averaged wind speed value. Optionally error bars are shown to indicate the variability or standard deviation of the power, and/or the wind speed within one or more power curve histogram bin.

In principle a histogram could show any statistic derived from the data within a bin. Usually a histogram employs an average, such as but not limited to the arithmetic mean.

On average it is expected that the power curve will not vary with wind direction for a wind turbine situated in flat terrain and no reason exists to favour one direction over another, subject to the possibility of wake affected angle sectors where other nearby turbines or obstacles may tend to produce a wake thereby altering the flow. However, in complex terrain the power curve may be found to vary considerably according to wind direction, due to complex flow arising as a direct consequence of the complex terrain shape. Therefore a convenient method of data analysis which may be used to study the impact of complex flow is to compare power curves per wind direction partition. Alternatively wind turbine nacelle direction may be used as a proxy for wind direction since the nacelle is usually controlled to align with the wind direction, albeit subject to yaw misalignment error. The presence of yaw misalignment error is not a problem given sufficient data when the yaw misalignment error is symmetrically distributed left and right since this should cancel out on average. However, if there is reason for asymmetry or bias in the nacelle yaw error with regard to wind direction then this may be corrected for by application of an offset which may be constant or varying, perhaps changing with wind direction itself or with regard to other parameters.

Data may include turbine power curve data, consisting of average fluid speed versus average power data pairs from a series of operational time intervals, which overall data set may be split into one or more partitions according to the value of another operational parameter, such as but not limited to average nacelle direction angle, or average fluid flow direction angle where averages are calculated per time interval.

Energy production capability per data partition may be compared by bin-wise multiplication of the corresponding power curve histogram per partition with a fluid speed frequency histogram employing the same fluid speed bin ranges as for the power curve. We may calculate production deficiency for a given data partition as the power curve of the most productive data partition minus that of the given data partition multiplied bin-wise with a fluid speed frequency histogram employing the same fluid speed bin ranges as for the power curve. Relative energy productivity per data partition may then be calculated as energy production capability per partition divided by the maximum energy production capability of all the partitions.

If energy production capability per data partition p is given by Eₚ, and within that data partition p the average wind speed per wind speed bin i is given by vₚᵢ, with the average power given pₚᵢ, and if we employ a fluid speed frequency histogram where the population of each wind speed bin i is given by fᵢ, then we may calculate the bin-wise multiplication as a summation Eₚ=Σᵢ{(fᵢ)·(vₚᵢ)}. If E_{q} is the maximum energy production capability for all data partitions p, where q denotes that partition with greatest energy production capability, and if energy capability losses per data partition are denoted as Cₚ, then Cₚ=E_{q}−Eₚ

One may calculate partition losses for a given data partition in a similar way to calculating production deficiency for the given data partition, but using a partition-based wind speed distribution (fₚᵢ) instead of a globally applied wind speed distribution (fᵢ) applied to all partitions. Specifically one may calculate partition losses as the power curve of the most productive data partition (q) minus that of the given data partition multiplied bin-wise with a partition based fluid speed frequency histogram employing the same fluid speed bin ranges as for the power curve. Therefore we may calculate Lₚ=Σᵢ{(fₚᵢ)·(v_{qi}−vₚᵢ)}. The partition-based wind speed distribution could be generated by computer simulation, or preferably it could be collected from historic operational data. We may calculate overall losses as a summation over all partitions of partition losses, L=Σₚ(Lₚ)=Σₚ(Σᵢ{(fₚᵢ)·(v_{qi}-vₚᵢ)}).

We may ascribe losses to complex flow, in which case we may refer to losses as complex flow losses. We may ascribe losses to wakes from other turbines or objects, in which case we may refer to losses as wake losses. We may ascribe losses to a combination of complex flow and wakes in which case we may refer to losses as losses arising from a combination of complex flow and wakes. However, one may apply a methodology to identify wake affected angle sectors, as is commonly applied within the art. If the losses are shown to be in non-wake-affected angle sectors then one may argue that the losses are not due to wakes. In this case when the losses have been ascribed to a combination of complex flow and wakes then one may deduce that the losses are due to complex flow. All calculated or measured quantities are subject to errors or uncertainty and standard methods of statistics may be applied to quantify errors and uncertainties.

It is understood that there are other reasons why a wind turbine power curve may exhibit apparent underperformance, including but not limited to authorised or unauthorised curtailment (such as noise curtailment, grid curtailment, maintenance curtailment, shadow flicker curtailment), or a system integrity problem (such as damaged blades, dirty blades, or other maintenance problems), operational errors, or sub-optimal parameter settings. It will be appreciated then when undertaking analysis to calculate power curve productivity, energy losses, complex flow losses, or other statistics it is commonplace, although optional, to exclude such data from the calculation so that the calculation provides assessment of performance under “normal” operating conditions.

One may argue that a wind turbine ought to be capable of operating in accordance with its best power curve irrespective of wind direction. Optionally the fluid speed frequency histogram used comes from historic data collected at the turbine, irrespective of wind direction. This represents the overall wind speed regime at the turbine. Optionally a computer generated wind speed regime may be used. Optionally the computer generated wind speed histogram is intended to be representative of the typical wind speed regime for a given turbine.

It is noted that energy losses, or energy productivity may be considered as absolute values in kWh or other units of energy, or alternatively they may be considered as relative values where they are given as a percentage or fraction between values calculated for different data partitions.

Those who are familiar with the art of wind turbine control will know that the typical HAWT power curve may be considered to operate through a number of regions. In particular Region 1 refers to the start up of the turbine moving from a state where there is insufficient wind into a state where there is sufficient wind that the turbine may start. Region 2 refers to the rise of the power curve where the control system generally aims to capture as much power as possible from the wind which is passing through the rotor area. Region 3 refers to a maximum power plateau where the turbine is operating at its full rated power and the control system limits the turbine from harvesting further power since this would be damaging according to the design rating of the turbine components. Region “1.5” may refer to the transition between regions 1 and 2. Region “2.5” may refer to the transition between regions 2 and 3.

Region 2 is of particular interest when there is a misaligned flow with respect to the rotor axis since this means the turbine does not see the full fluid flow available and therefore the Region 2 control objective of harvesting maximum power from the wind is not fully realised. By altering parameters it is possible to reduce a substantial amount of the power loss due to misalignment.

The data set may be cut to exclude time intervals when one or more parameter is outside of a given range in order that the energy losses calculation focuses on a particular operating regime of the turbine, such as but not limited to “Region 2 Control” which might potentially be represented for some turbines by selecting power curve data within an operating regime of average wind speed within a particular range, such as but not limited to the range 2-12 m/s.

Therefore it is possible to quantify the efficacy of a parameter change at improving the operational outcome within a given operating regime, such as but not limited to the regime of Region 2 control.

It will be appreciated that there are many possible data selection cuts which may optionally be applied when calculating a parameter. For example it may be desirable, when working with 10-minute average operational wind turbine data sets, to require a wind turbine availability indicator to be above or at a threshold, such as 10-minute “system OK seconds” equal to 600. This would exclude data when the turbine is in a fault state for part of the 10-minute period. Data with logging rates higher than every 10-minutes, such as 1-minute average data, or 5-second average data, or 1 Hz data, or 10 Hz data, or even higher rate data, may also be used.

An energy losses calculation for a given operating regime indicate that a control adjustment or controller retrofit may be beneficial within that operating regime, as compared with an alternative operating regime without the said control adjustment or controller retrofit, and the energy losses calculation may therefore indicate potential gains in annual energy production that might be obtained by the wind turbine owner when applying the control adjustment or retrofit.

An energy losses calculation, or energy production capability per data partition, or energy losses per data partition, or energy losses per operating regime, or energy production capability per operating regime, may be automatically calculated and provided within a turbine SCADA (Supervisory Control And Data Acquisition) system, either as a numerical data point within the SCADA database or in graphical form within an associated Graphical User Interface.

A dataset may be split into partitions according to a first parameter of the dataset (such as but not limited to splitting the data into wind direction ranges), and a second parameter may be calculated from the data within each partition, where linear or non-linear interpolation is used to produce a unique value of the second parameter, given any distinct value of the first parameter. This allows for a set of discrete (x,y) samples to be converted into a continuous, or piece-wise continuous function y=y(x).

It will be appreciated that data histograms may be formed in many dimensions, such as in three or more dimensions although this may not be useful for visualisation purposes of those entities whose visualisation capability is limited to three dimensions.

It is noted that N-dimensional vectors (x1, x2, x3, . . . , xN) according to a given basis in N-dimensional space may potentially be transformed into N-dimensional vectors (y1, y2, y3, . . . , yN) with respect to a different basis. Therefore it is noted that data histograms of the same data set may be formed by partitioning the data with respect to the second basis. The same data may be viewed from a different angle in order to arrive at a different view.

System parameters calculated, adjusted or constrained according to data may include one or more system performance parameter. For example in the case of a turbine one may estimate an energy productivity parameter, or alternatively one may estimate a losses parameter, such as but not limited to a complex flow losses parameter. In the case of a vehicle system such as a helicopter, or a rocket during launch, one may define a system performance parameter in terms of the stability of the flight or how closely the actual trajectory adheres to an intended trajectory. For example one may calculate a positive definite root mean square residual distance between actual and intended flight trajectory and this parameter may be inverted so that greater values indicate greater performance. Many possible metrics or indicators of performance are possible.

One may contemplate machine learning as a means by which system parameters may be optimised or improved. One simple method of machine learning is trial and error where the machine tries different input parameters, evaluates a performance metric and concludes (or learns) what are the input parameters which give rise to best output.

A preferred method of machine learning is the neural network (NN). A neural network may be presented with training data consisting of many input parameter sets or data sets along with their respective one or more output parameters. Output parameters may include one or more performance metric.

In case of a turbine one possible performance metric could be energy productivity, optionally defined as power curve multiplied bin-wise with wind speed distribution. The turbine employs many control parameters under the influence of many environmental parameters, including fluid flow parameters. A machine learning system may learn which parameters are best for a given turbine in order to maximise energy productivity. Metrics other than energy productivity are possible. Without loss of generality performance metrics may be designed for reducing fatigue loads, or vibrations, or extreme loads, or avoiding certain operational regimes considered risky. Optionally constraints or requirements may be applied to data populations in calculating energy productivity, or any other metric. A machine learning system may simultaneously work toward learning which parameter settings are suitable to optimise operation with respect to one ore more performance metric. A machine learning system may learn what type of wind inflow gives rise to greatest fatigue loading of a turbine. Therefore such a system could eventually be used in order to minimise or reduce the fatigue loading of the turbine when viable actions may be initiated by the system in order to reduce the loading. This could enable turbine assets to have a longer safe working lifetime and thereby add value to the turbine asset (owned by a turbine owner) or turbine product (as sold by a turbine manufacturer). Similarly a machine learning system may learn what type of data or parameter sets give rise to improved energy production of a turbine. Therefore a turbine asset may be made more productive during its operational lifetime. This also adds value for the turbine asset owner, and manufacturer.

The present invention offers new opportunities in machine learning. Many machine learning methods, including neural network methods, are known by a person skilled in the art and could be applied within the present invention. Machine learning may also be referred to as “Artificial Intelligence” or “AI”.

A turbine may have a control system which employs a machine learning component whereby data, optionally LIDAR data, is fed as input data into a machine learning model such as a neural network. It will be appreciated that there are many types of machine learning and indeed there are many variants of neural networks.

One embodiment of a neural network is a multi-layer neural network, or a multi-layer peceptron. In such a network the neurons are arranged in layers and neural connections are typically between adjacent layers. A multi-layer neural network can be capable to handle non-linear problems whereas a single layer neural network is capable only of linear separation. A multi-layer neural network, especially one with many layers, may be referred to as a “Deep Neural Network” and may be said to be capable of “Deep Learning”, which is a subset of machine learning. A “Neural Network” (NN) may be referred to as a “Neural Net” or an “Artificial Neural Network” (ANN).

The number of neurons in a layer or in a neural network can be adjusted. The interconnectedness of the neurons may be adjusted. Neural connections between a first neuron and a second neuron may have associated a weighting factor which may be applied in some way such as multiplicatively to the output of a first neuron en route to input at a second neuron. Activation functions may be applied to the neural processing of data.

Techniques such as backwards propagation are known to a person skilled in the art and may or may not be applied within neural network machine learning. Methods of supervised learning and unsupervised learning are known to a person skilled in the art.

Supervised learning may involve provision of both input data and the corresponding output data to a machine learning system (possibly a neural network) and repeating the process including a process for evolving the machine learning system (possibly a neural network) weighting factors to account for each additional training case. Testing the predictive success of a machine learning system (possibly a neural network) can be done by providing only the input data and then comparing the corresponding output data (from a real system, or system to be predicted) with the output provided by the machine learning system (possibly a neural network). If they agree then this is a success. Testing with a population of input and corresponding output sets allows calculation or estimation of a success rate which is the number of successes divided by the number of test cases. Where applicable, in case of a logical output, a false alarm rate may also be estimated which could be the number of false positives divided by the number of test cases.

We may define terminology of a machine learning “performance rate” to refer to either or both of “success rate” and “false alarm rate” for the machine learning system. Note that we may consider the output provided by the machine learning system (possibly a neural network) to be a predicted output which may be compared with the true output quantity corresponding to the given input case. A “true output” may be an output which is observed in a real system when that real system is subject to an observed set of (real) inputs. It is noted that observed input or output values may be misread since it is possible that an observation may be faulty. It is noted that the input data for a machine learning system (possibly a neural network) may be an estimate of one or more true value. For instance when we take a measurement of a physical quantity we cannot generally access the true physical quantity and the sensor or measurement device is subject to experimental error. Therefore measured quantities may be considered as estimates of true underlying quantities. Similarly the output data with which we train or test a machine learning system may be subject to measurement or estimation uncertainty and may be considered as an estimate for the output quantity or quantities. It is noted that measured or estimated quantities may have associated with them uncertainty or error estimates and that these quantities may also be taken into account within machine learning systems. For instance the uncertainties of a first input data vector may constitute a second input data for the machine learning system. Similarly the output data uncertainties associated with a first vector of outputs may constitute a second vector of outputs. In this way it is possible for a machine learning system (such as a neural network) to predict outputs and also to estimate an uncertainty on those predictions.

Input data and output data may be single data items or vectors or arrays of many data items. Input and output data may be of any data type including but not limited to binary, integer, real number, logical, or case option. It can be possible to divide an input and corresponding output data set into two or more partitions. One may train a neural network on any or all of the partitions. One may test the success rate or false alarm rate of a machine learning system (possibly a neural network) trained with on a first partition by using the data of a second partition and vice versa.

If a machine learning system (possibly a neural network) is found not to perform adequately then it may be possible to gather further data for further training and then re-test hoping to find improved performance. If a neural network is found to have adequate performance then it is possible to start utilising the neural network for its chosen purpose and to continue gathering input and output data for further training in the hope of improving the performance further beyond “adequate”. For instance a controller, such as a turbine controller or a blade pitch angle controller, utilising a neural network could invoke new functionality once the machine learning/neural network success rate was deemed adequate, perhaps with 95% success.

After continued data collection it might be found that the machine learning system (possibly a neural network) had reached success rates of 99% at which case the control system may invoke additional functionality. Therefore there may be one or more success thresholds indicating firstly a sufficient level of training and then subsequent upgrades. One may conceive of providing neural network software which will invoke advantageous functionality after an initial training period but continues to gather training data which may be used for further training or further testing and that when the neural network parameters (such as neural pathway weighting factors) reach another level then further functionality could be triggered or initiated.

Performance rates (including success rates or false alarm rates) may be uncertain such that one may estimate a success rate and one may also estimate a success rate uncertainty. A method for estimating success rate uncertainty can be to partition the overall available test data which was not used for training the network. And then one may calculate different success rates for the different test data partitions such that the average of those success rates may be taken as the overall success rate estimate whereas the standard deviation of those success rates may be taken as the overall success rate uncertainty.

It will be appreciated that checking whether a performance rate is above a performance threshold is equivalent to checking whether the negative of the performance rate is below the negative of the performance threshold where the negative of the performance threshold may be considered to be an alternative performance threshold.

Where the output data may consist of a vector of data items rather than a single data item it will be appreciated that a minimum threshold of machine learning success may be applied to each element of the machine learning output vector. It may be the case that for a given machine learning system (possibly a neural network) version each output element may have its own performance rate which may differ from the performance rate required of other output elements for a given machine learning version release.

It can be possible to undertake machine learning system (possibly a neural network) optimisation for one or some of many outputs by ignoring or “switching off” some or all of the other outputs during training. This is equivalent to setting up the machine learning system (possibly a neural network) for only one or some of the many outputs. When training a machine learning system (possibly a neural network) for a vector of outputs then one may employ a norm or measure of the distance between two vectors within a vector space as a measure of closeness between the machine learning system (possibly a neural network) output vector and the target (training or test data) output vector.

In case of series production of a given turbine model it is possible for a turbine or vehicle manufacturer to evolve a neural network over time and incorporate the neural network processing into successive software version releases or customer upgrades as performance improves.

It could be possible that industry standards bodies gather data or require provision of certain data in order to employ machine learning for deciding on new structural integrity requirements, design standards or new safety functionality. This could provide a new and additional machine learning mechanism for improving industrial standards. It is noted that adoption of machine learning does not imply that human learning is not beneficial. Operator experience continues to be valuable. Both human and machine learning may be employed by a control system. Human learning can be good at some types of learning and machine learning can be good at other types of learning. In particular machine learning can be advantageous when it comes to fast processing of vast numeric data sets.

One embodiment of a neural network can be a massively interconnected neural network where neurons are not necessarily arranged in layers. After all the human brain neurons are not strictly arranged in layers. It can be the case that when one neuron is activated other “nearby” neurons may also be activated. This may be embodied within a mathematical computing neural network by establishing a distance norm defined on individual positions of the respective neurons and by a mathematical processing which adjusts or amplifies the corresponding neural weights. An amplification factor in principle may be any real number.

Data such as LIDAR data may be provided as input to a machine learning system along with loads data from loads sensors. Therefore a machine learning system may be trained to learn what input data give rise to greatest loads within a structure, such as a turbine or a vehicle.

Machine learning may feed into a control system warning or alarm, or initiate an automatic control sequence. Machine learning may feed into a model for improving structural design.

Successful machine learning is achieved when the machine learning system is able to predict the loads arising (or predict that the loads are above a warning/alarm threshold threshold) with a high level of success (and a low level of false alarm). If the learning is insufficiently successful then more training data may be required. However it may be that the input data is dimensionally insufficient to determine the outputs. In that case it should be recognised that further relevant data attributes may be required for successful machine learning. In general successful machine learning is achieved when the machine learning system is able to predict the outputs based on given inputs with a high level of success. It will be appreciated that any available data could be employed as input data and output data and there can be any number of inputs and any number of outputs.

A collection of data or a data set may be referred to as a database. A database may include data corresponding to a single turbine, or a set of turbines, or a set of turbines denoted by a common model number, or turbines of a particular type, or all turbines in general. Any database or data set partition may be chosen as training data (and test data) for machine learning.

Machine learning could be turbine specific. A turbine could continue to learn throughout its operational lifetime by keeping a historic log of its relevant parameters. Such historic data logging and machine learning may be especially interesting to the turbine owner and operator, or other industry participants. Alternatively machine learning could be turbine model specific where operational data from all turbine models of a given type is transmitted to a central database. This may be especially interesting to the turbine manufacturer or other industry participants. This information could be used to highlight possible differences or abnormalities of a specific turbine from its peer group. Alternatively machine learning could assist with turbine structural design by including in the data logging a generalised description of turbine configurations and main structural design parameters. Such a database might be maintained by turbine manufacturers or an industry body or another industry participant. In this case machine learning could be applied in order to optimise the structural design of turbines. By including in the data logs also the main parameters defining the application it could be possible for machine learning to learn what turbine parameters are most (or least) suitable for different categories of application. Optionally this might refer to categories of deployment terrain, or turbulence regime, etc. This could allow improved turbine selection for a given application. Such a database and machine learning tool might be maintained by a turbine manufacturer, an industry body, a turbine owner or another industry participant.

It could be possible for a manufacturer or other industry participant to maintain one or more operational turbines with which to gather operational data for machine learning in order to evolve the turbine control parameters. This could allow the provision of controller upgrades for other turbines of the appropriate model or type every so often as the manufacturer sees fit or beneficial.

Different types of data logging may be employed such as event based logging when an alarm is raised, or regular time series logging to monitor a given observable over time. In principle machine learning can handle all types of data. Data, such as but not limited to converging beam LIDAR data, may be collected in order to characterise local site conditions, including where some or all of the LIDAR data is collected prior to deployment of the turbine.

Data, such as LIDAR data collected in order to characterise site conditions, may be processed in order to calculate statistics relating to the conditions (such as wind conditions) including but not limited to mean, standard deviation, peak position, peak width, peak full width half maximum. Data may be processed including a curve fitting process by various methods including but not limited to least squares fit. Data processing may include interpolation or extrapolation of curve fitting beyond the collected data range or within gaps in the collected data range. Data may be bin averaged or arranged in frequency histograms. Some or all of the data may be binned and may be bin-averaged per data bin and standard deviations may be calculated per data bin. LIDAR or wind data may include one or more of the wind shear distribution, the wind veer distribution, the horizontal wind speed distribution, the wind direction distribution, the wind gust distribution, the turbulence distribution, the non-horizontal wind flow angle distribution, maximum permissible wind speed, wind speed measured or estimated at an absolute position, wind speed measured or estimated at a second position relative to a first position.

All of the above discussion surrounding machine learning application to turbine data and turbine parameter improvement may similarly apply to machine learning application of vehicle data and vehicle parameter improvement. A special case of vehicle is a vehicle incorporating a rotor, which may have blades similar to a turbine rotor which may have blades.

It is noted that a helicopter has blades which may employ a cyclic blade pitch angle once per revolution around the rotor. It is noted that a helicopter may act in some operational modes quite similar to a wind turbine. For instance if a helicopter is in emergency descent then it may adjust the blade pitch into an emergency configuration, possibly without engine power, whereby they produce reduced overall lift and allow the helicopter to descend quickly toward the ground but somewhat balanced with upwards thrust force exerted on the main rotor which continues rotating. This is analogous to thrust on a wind turbine rotor. Upward thrust partially balances downward gravitational weight and may be used by the skilled pilot to soften an emergency landing.

Also of some similarity between wind turbines and helicopter rotors is the possibility offered by cyclic pitch control, such as but not limited to a sinusoidal variation in pitch angle once per rotor revolution. The amplitude and phase of a helicopter cyclic blade pitch angle system may be used to adjust the overall thrust vector component in the horizontal plane at a given angle in the horizontal plane for a helicopter in normal level flight, or hovering.

It is noted that a helicopter equipped with data may adjust its cyclic blade pitch control in response to that data. In particular the data can be data on the local wind conditions, either as a single general characterisation of wind velocity, wind speed or wind direction in the vicinity of the helicopter, or indeed as a multi point measurement of wind conditions surrounding the helicopter in space-time. In particular such wind measurement could be offered by LIDAR, including Doppler LIDAR, including converging beam Doppler LIDAR. This may assist emergency landing.

A helipad or heliport incorporates a platform where a helicopter may land and take off. It is noted that a helipad may incorporate a wind measurement system and means to transmit the data or a corresponding signal to a helicopter, such as at but not limited to a helipad on an offshore platform such as an offshore wind transformer station, or on an offshore wind turbine, or on an offshore oil or gas rig, or on a ship, such as a goods transportation ship, or indeed a helipad on an onshore building, optionally a hospital, or a ground based onshore helipad. Alternatively a helicopter may be equipped with its own measurement system to provide wind velocity data. Instruments may provide relative wind velocity data and this may be transformed into absolute wind velocity data based on absolute position, orientation and velocity data also provided by on-board instruments. It is noted that on-board wind measurement instruments such as but not limited to pitot tubes offer a measurement which is subject to the bow wave, wake and rotor effects of the helicopter itself. However, a helicopter equipped with LIDAR data may potentially obtain wind data at any relative or absolute position with respect to the helicopter, depending on the LIDAR parameters, optionally including LIDAR beam steering parameters such as one or more relative or absolute beam angle. Preferably the LIDAR would be a converging beam LIDAR. Optionally the LIDAR may produce a plurality of wind measurements at a corresponding plurality of points in space-time. This could allow the helicopter to abort or postpone a landing, depending on sudden gusts of wind or other wind data parameters. This could allow the helicopter to adjust its flight control parameters in response to anticipated wind conditions using look ahead LIDAR measurement. In particular this could allow the helicopter to apply or adjust a parameter of cyclic blade pitch variation such as blade pitch adjustment of the aerodynamic angle of attack, or a phase angle offset according to a compass bearing in the horizontal plane, or according to another angle in a non-horizontal plane fixed with respect to the helicopter main frame of reference, possibly perpendicular to the main rotor axis. Optionally data may be transmitted by any type of communication system between a vehicle and a landing station, such as but not limited to a helicopter vehicle and a helipad. Optionally data may be transmitted between a first vehicle and second vehicle. Data may be employed within a vehicle control system, such as but not limited to a rotor-craft landing control system. Such a control system may contain parameters derived at least in part from the data. For example a converging beam LIDAR could measure and provide wind shear data at or near a helipad and a helicopter control system could incorporate data processing in order to safely abort landing or take off in cases of extreme wind shear. Generally a converging beam LIDAR may offer measurements of wind data vectors at one or more locations in space-time. This allows for the provision of information or statistic derived from any characteristics of wind flow including but not limited to wind velocity, vertical wind shear, vertical wind veer, horizontal wind shear, horizontal wind veer, gusts, sudden wind direction changes, down drafts, non-horizontal flow, three-dimensional wind direction, turbulence, turbulence intensity, three-dimensional turbulence, three-dimensional wind speed, horizontal wind speed, vertical wind speed. A physics model may calculate forces impinged on a vehicle by the wind, including over-turning forces and moments of force. In general a vehicle may incorporate control systems which may optionally include computer models employing data inputs in order to calculate parameters for vehicle control. Different types of vehicle control may include guidance, safety systems, fuel efficiency, trajectory correction and passenger comfort systems.

Converging beam LIDAR (3d laser wind measurement) may be aimed at the wind energy industry but other potential applications are of interest, including crane operations, aviation runways, helipads and also space launch. Similar products can be applied in different industries but system parameters, design choices and component specifications must be altered to account for differing measurement requirements.

The wind conditions during a space launch can be significant for a number of reasons. Firstly, extreme gusts, turbulence, wind shear/veer gradients, non-horizontal flow can cause significant overturning moments which could be a safety hazard at launch, or cause an alteration in initial heading resulting in increasing trajectory errors. Secondly, during flight side winds may blow the rocket substantially off its intended trajectory which requires additional gimballed rocket motor control corrections and associated use of fuel. Thirdly, launch windows can be affected by wind conditions which means that accurate wind knowledge is needed in order to determine the beginning and end of “wind OK” windows—increased accuracy of wind measurement implies reduced uncertainty and reduced need for margins of safety with the result that safe launch window indications are increased (avoid false “not OK”) and unsafe launch window indications are decreased (avoid false “OK”);

Space launch failures can be costly. Space insurance costs may be substantial. Therefore improved wind measurement offers a number of potential advantages including (a) reduction in risk of accidents, including possible losses such as cost of rocket, cost of payload, possible third party damage and legal costs, cost of increased insurance premiums; (b) reduction in risk of launch postponement, including cost of crews and equipment mobilisation, travel, cost of delay in payload delivery to orbit; (c) reduction in risk of rocket trajectory going off course which might lead to errors in payload deployment position/orbit; (d) reduction in risk of rocket trajectory going off course and breaking regulatory rules such as rocket flying over densely populated areas; (e) reduction in risk of rocket trajectory conflicting with other aviation; and (f) to give confidence to space insurers, consumers, regulators and other stakeholders and assist minimising space launch insurance costs.

Apart from assisting commercial launches a converging beam LIDAR can be of great utility to a space port during R&D testing since it offers a depth of 3d wind profile or wind map data not available elsewhere. This data can be highly beneficial towards understanding the effects of wind during launch tests, as well as offering stop/go decision-making data in operational timing of the launch. Hours and days ahead weather forecasting using weather radar and forecasting simulation is used for general scheduling but this only gives a rather coarse indication of wind conditions. Converging beam LIDAR offers dynamic “real time” direct 3d measurement.

Balloons may be employed but they have certain disadvantages compared to converging beam LIDAR, such as (i) balloon-measured conditions are given at a single point in space at a given moment in time whereas a converging beam LIDAR solution can repeatedly scan from point to point in a fraction of a second, cycling through a series of measurement points repeatedly, or programmable as required; (ii) the balloon will not follow the rocket trajectory and will be increasingly blown away over time whereas the LIDAR measurement points can be maintained precisely on the intended trajectory; (iii) a LIDAR system is re-usable over many launches and does not produce environmental waste whereas balloons are used once and difficult to recover. It is noted that balloons could be used together with converging beam LIDAR profiling. This can offer added redundancy, resilience and data validation.

Wind flow data provided by measurement systems including LIDAR, including converging beam LIDAR, or one or more parameters derived from that data, may be provided to a vehicle such as a space rocket, including its launch control, for logical decision making regarding whether or not to launch at a given moment, or to postpone. Similarly, such data may be transmitted to the space rocket during its launch phase, enabling control measures to be undertaken.

Wherever a space rocket launch is referred to one may equally apply the same reasoning to other vehicles including but not limited to aeroplanes, space-planes, space shuttles. The application may be on an astronomical body other than planet earth, including but not limited to the moon, another planet, another planetary moon, an asteroid, a comet, a space station, a space craft or a satellite. It is noted that Doppler LIDAR performs better when there exists a fluid flow for Doppler scattering. However, other data including hard target LIDAR ranging data for situational awareness could be used instead of Doppler LIDAR data as input data for adjusting a parameter of the vehicle.

In the case of a space port, airport or helipad within an atmosphere, such as on earth, then a beam steering LIDAR may be used to make measurements along a chosen trajectory or locus of points. Measurements along a vehicle's anticipated trajectory could be arranged to provide a vehicle with fluid flow measurement such as but not limited to wind velocity data in anticipation before the vehicle experiences such flow. This allows for anticipatory control. The data, or parameters derived from it, may be transmitted between the LIDAR and the vehicle control systems.

In one embodiment the data comes from ground based LIDAR, optionally Doppler LIDAR, preferably converging beam Doppler LIDAR, optionally ground based converging beam LIDAR in order to provide wind measurement, such as three-dimensional wind velocity measurement. Optional beam steering or switching allows for controlling the beams to converge at a series of chosen measurement points within space-time. The measurement points may be pre-programmed. Alternatively the measurement points may be calculated or re-calculated based on provided vehicle data such as but not limited to (i) vehicle position, (ii) vehicle velocity, (iii) vehicle orientation (roll, pitch, yaw), (iv) vehicle way-points plan. Optionally such data may be measured on board the vehicle. Optionally such data may be transmitted to a LIDAR beam steering control system.

In another embodiment all of the above may apply but the LIDAR might not be mounted on the ground. In principle the LIDAR might be mounted any where, including on the vehicle itself, or on another vehicle such as but not limited to a drone.

The invention will now be described, firstly in brief and subsequently in further detail, solely by way of example and with reference to the accompanying drawings in which:

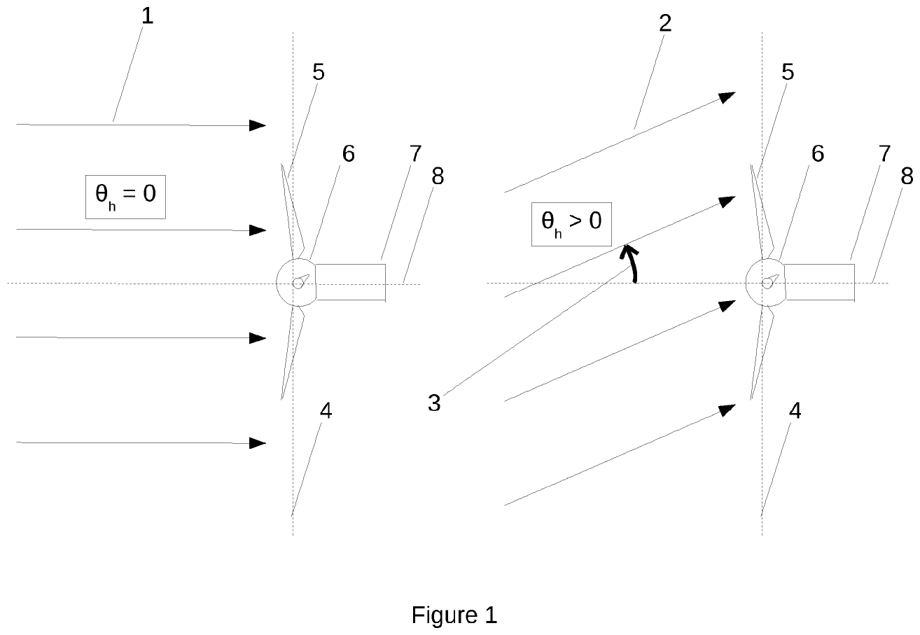

FIG. 1 shows a plan view of a horizontal axis wind turbine, firstly (on left) when aligned with the horizontal wind direction, and secondly (on the right) when misaligned due to yaw error.

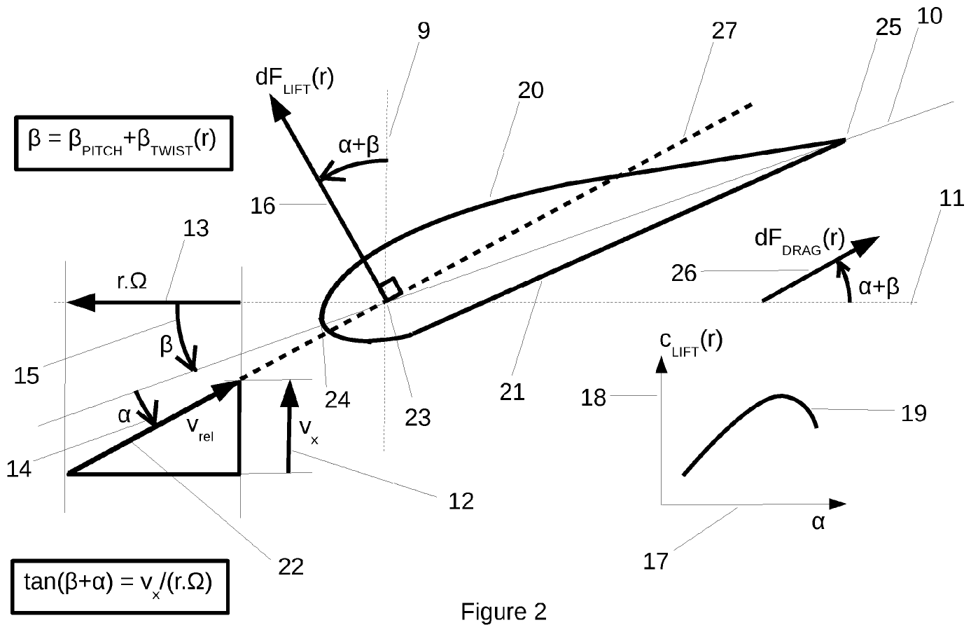

FIG. 2 shows the aerodynamic forces on a wind turbine blade element at a radius r, and that they are similar to those of an aeroplane wing in cross section but where the relative air speed and aerodynamic angle of attack are provided in a first component by the wind velocity, and in a second component by the rotational speed of the blade element within the rotor plane.

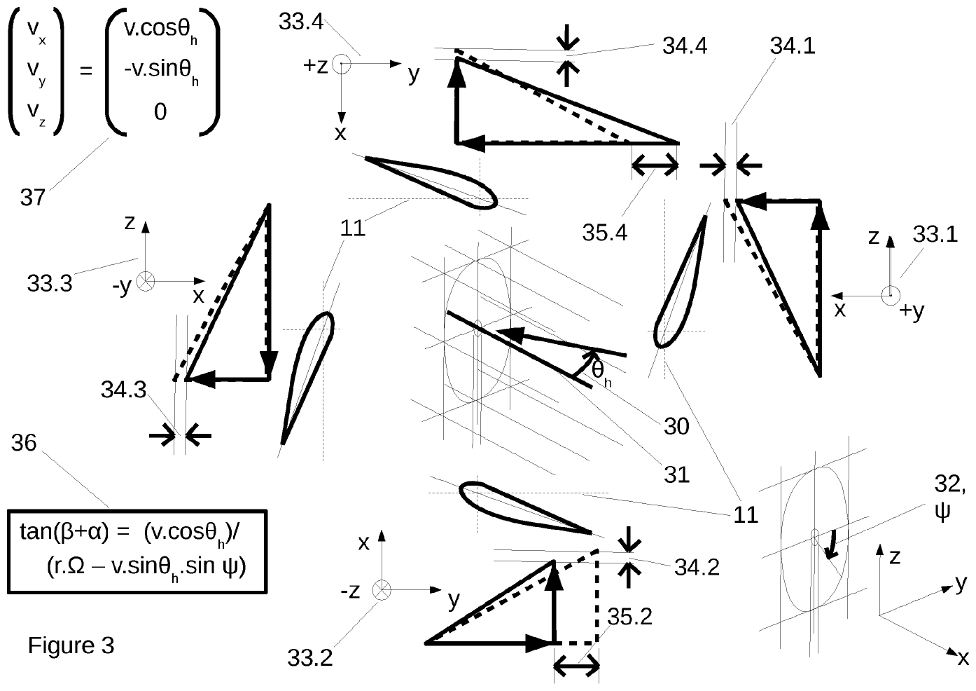

FIG. 3 shows how a horizontal misalignment, with respect to the rotor axis, of the wind velocity direction gives rise to a cyclic variation in both angle of attack and relative airspeed for any given blade element. Four views, along the blade length towards the rotor centre, are shown per 90 degrees interval of blade rotation ψ around the rotor axis.

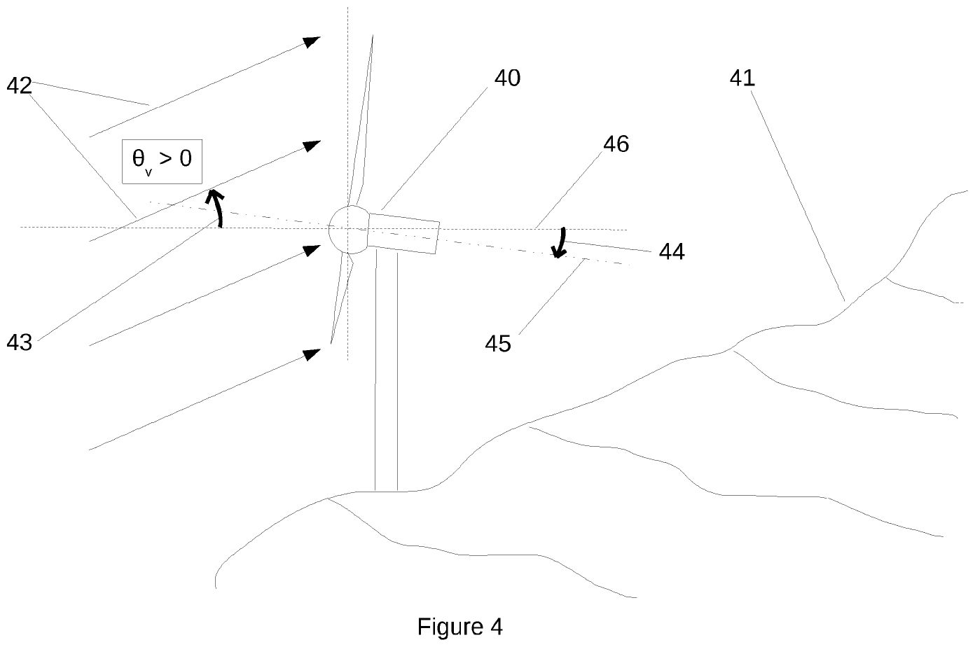

FIG. 4 shows a wind turbine situated on a Scottish hillside in the case where the wind is not horizontal but running approximately parallel to the terrain and from a direction where the terrain is sloping downward from the turbine such that the wind inflow is running up the hill toward the turbine at a non-horizontal flow inclination angle which may be effectively increased by a rotor axis tilt angle.

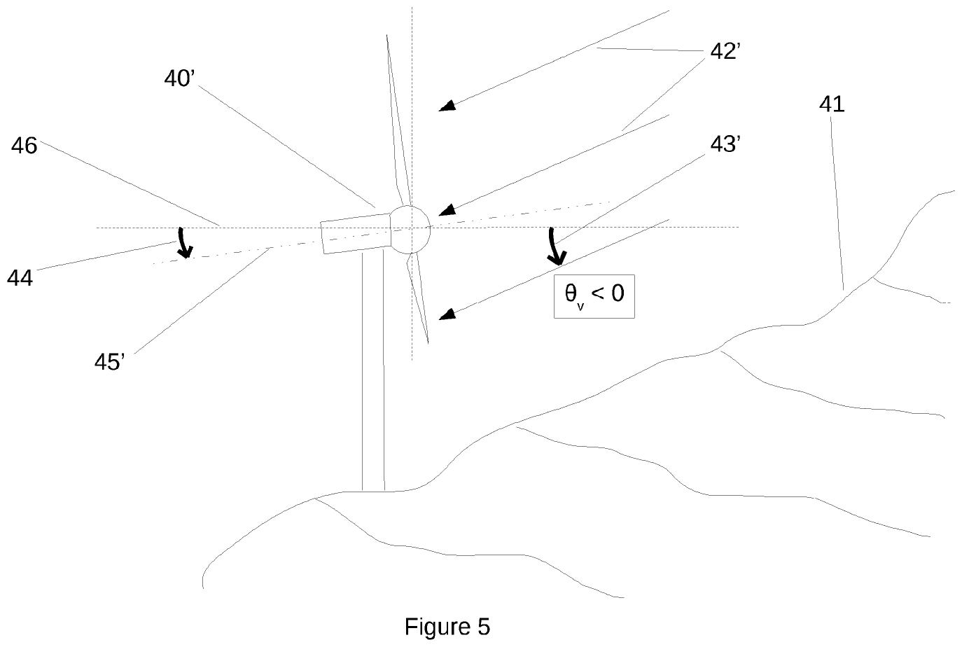

FIG. 5 shows the same turbine where the wind is coming from the opposite direction from uphill where a rotor axis tilt angle effectively reduces flow misalignment, with respect to the rotor axis, due to the flow inclination angle.

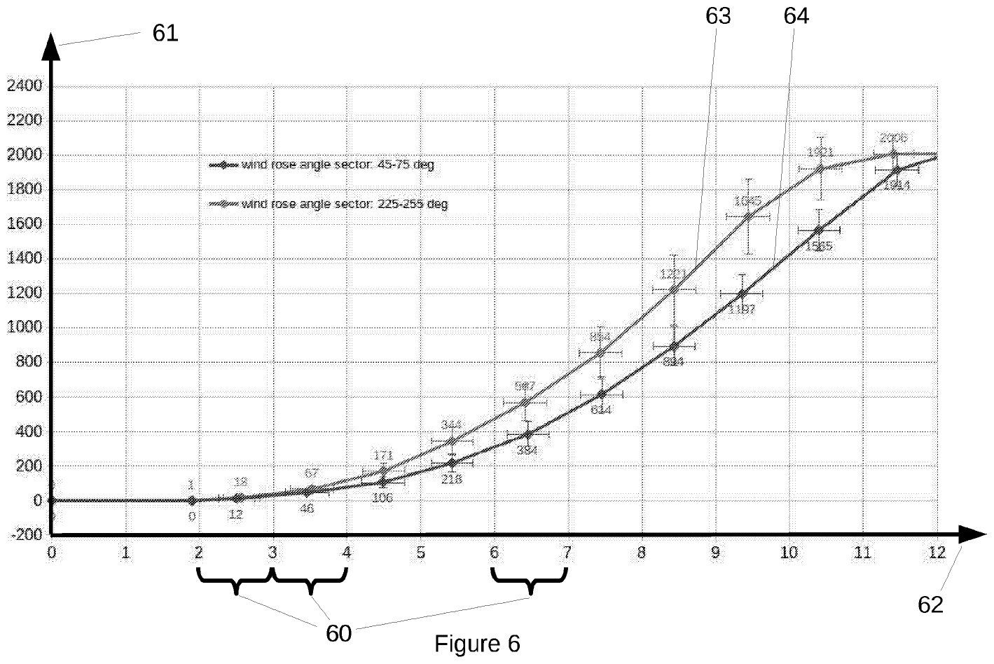

FIG. 6 shows actual operational power curve data from such a turbine situated on a hillside, for two data partitions constituting opposite wind direction sectors (180 degrees apart) where the power plotted per the ordinate axis per wind speed bin partition on the abscissa axis is found to be substantially greater throughout the power curve rise for one wind direction sector (the upper trace), as compared with the other wind direction sector (the lower trace).

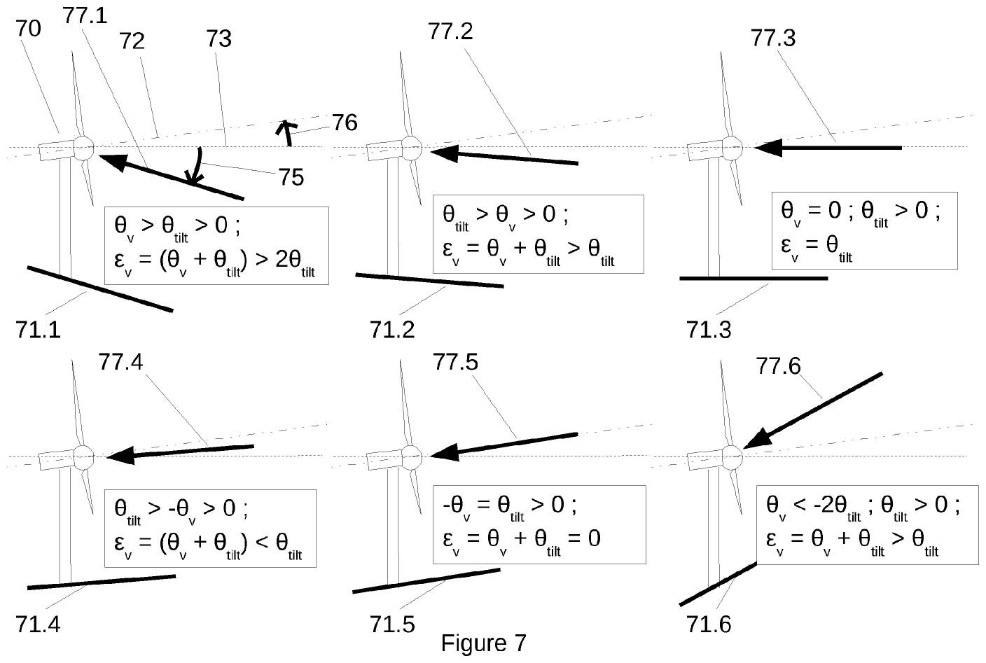

FIG. 7 shows a number of different flow inclination conditions where the tilt angle exacerbates or counteracts misalignment, which may be taken into account during improved wind farm planning and turbine layout.

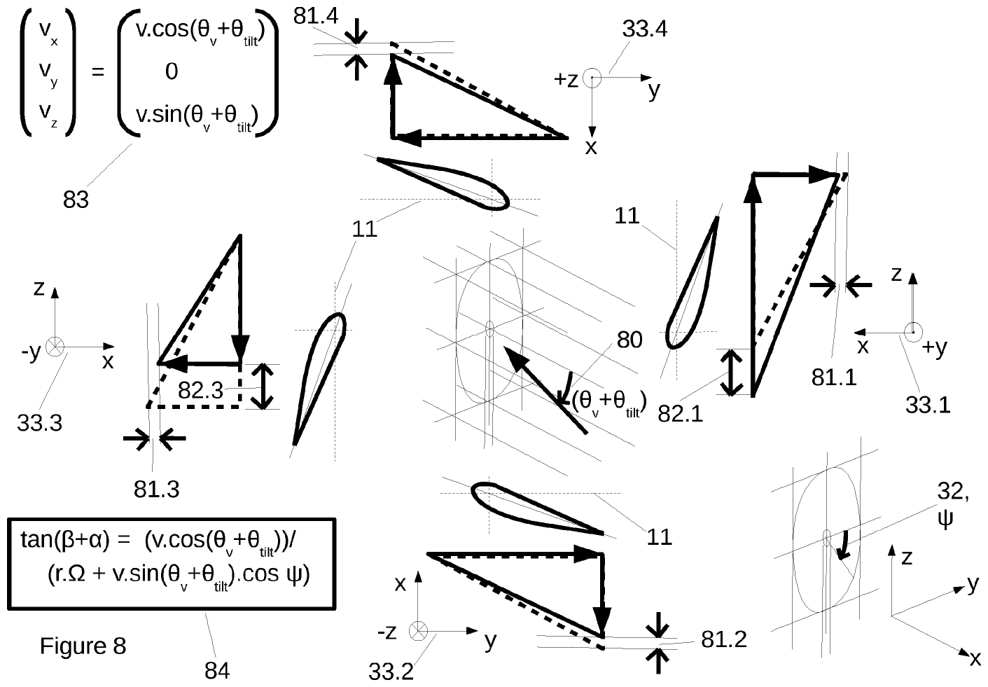

FIG. 8 shows how a vertical misalignment (arising from a combination of vertical flow inclination and rotor axis tilt angle), with respect to the rotor axis, of the wind velocity direction gives rise to a cyclic variation in both angle of attack and relative airspeed for any given blade element. Four views, along the blade length towards the rotor centre, are shown per 90 degrees interval of blade rotation ψ around the rotor axis.

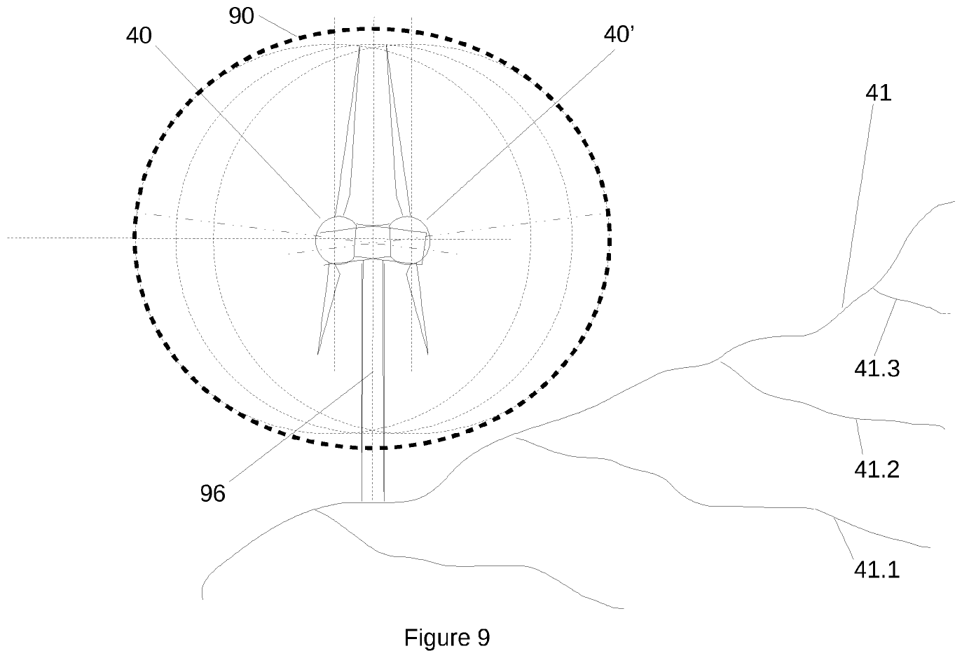

FIG. 9 shows how a typical wind turbine rotor rotates within a volume which is not quite perfectly spherical but rather a slightly oblate spheroid contained within a minimal ellipsoid volume.

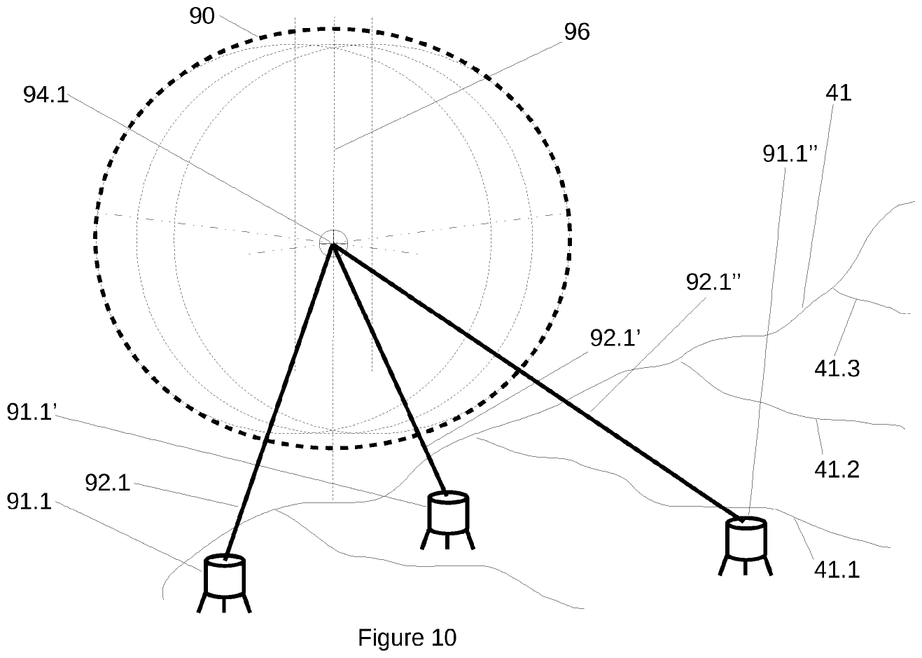

FIG. 10 shows a plurality of ground mounted LIDARs may converge their beams to a measurement point within the volume which would be swept out by a turbine of known dimensions if it were installed at a given position.

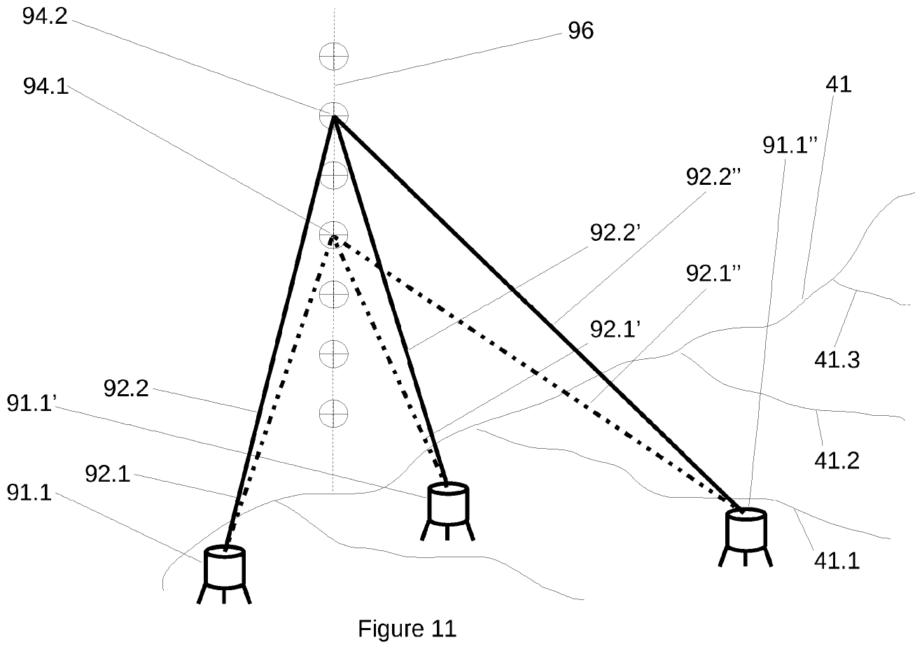

FIG. 11 shows how a plurality of ground mounted LIDARs may converge their beams to a plurality of points arranged on a vertical axis, so as to replicate wind measurements which might be provided by a meteorological mast if it were installed at the given location.

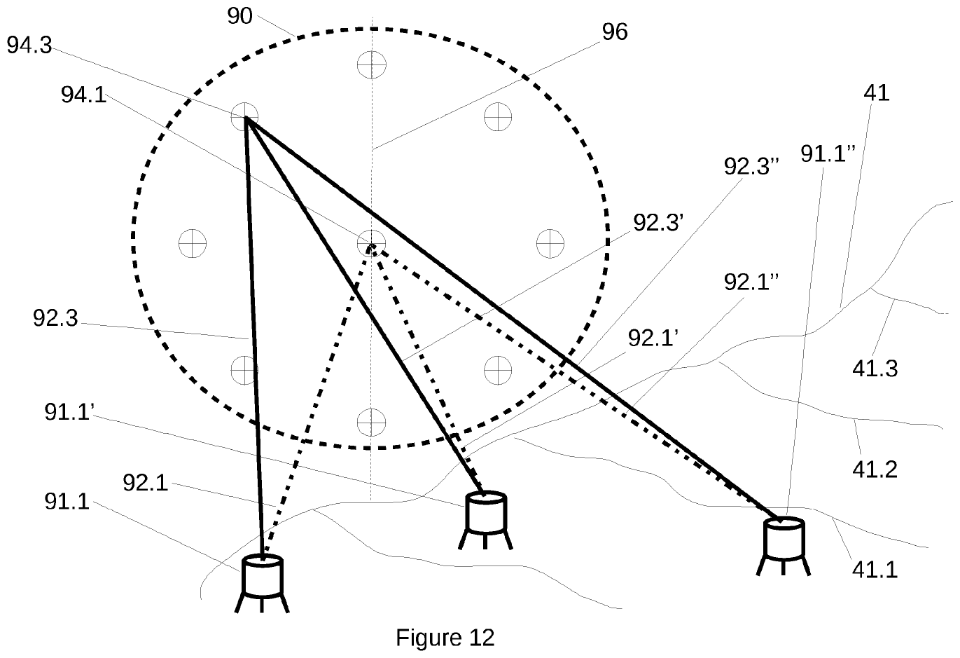

FIG. 12 shows a plurality of ground mounted LIDARs converging their beams to a plurality of measurement points throughout a planar region which might be indicative of a rotor plane when the wind turbine rotor is pointing toward a given wind direction.

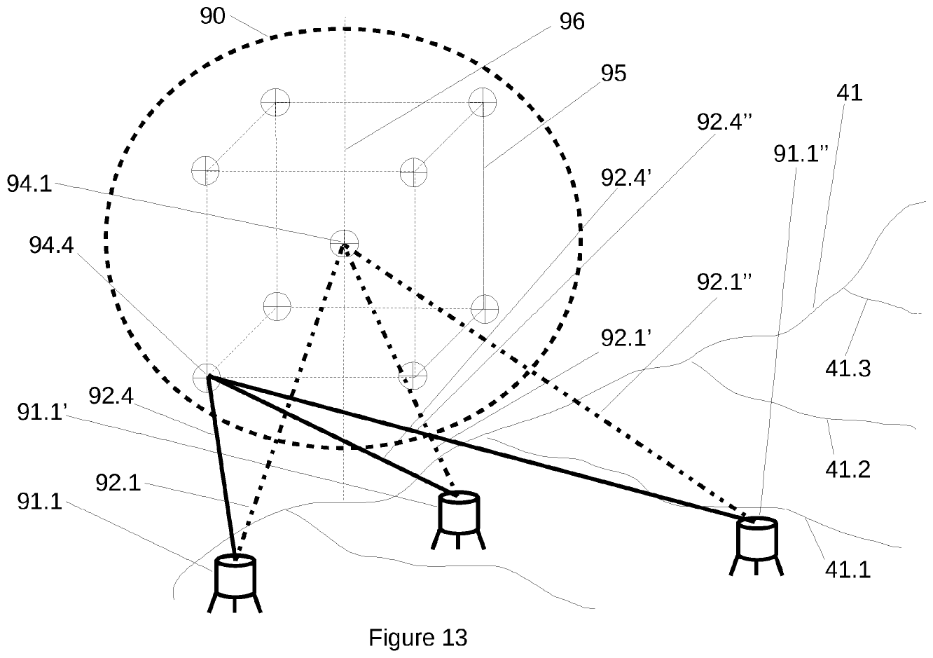

FIG. 13 shows a plurality of ground mounted LIDARs converging their beams to a plurality of measurement points throughout an ellipsoid volume.

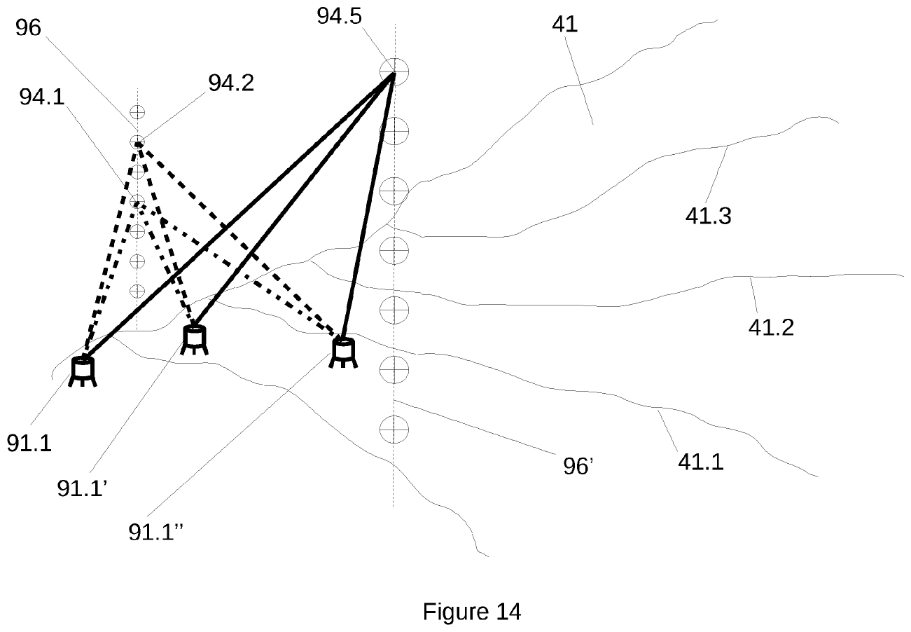

FIG. 14 shows how three ground mounted LIDARs may converge their beams to one or more points at one possible location, and also to one or more points at another possible location, possibly replicating the measurements of multiple meteorological masts through a single triple LIDAR deployment.

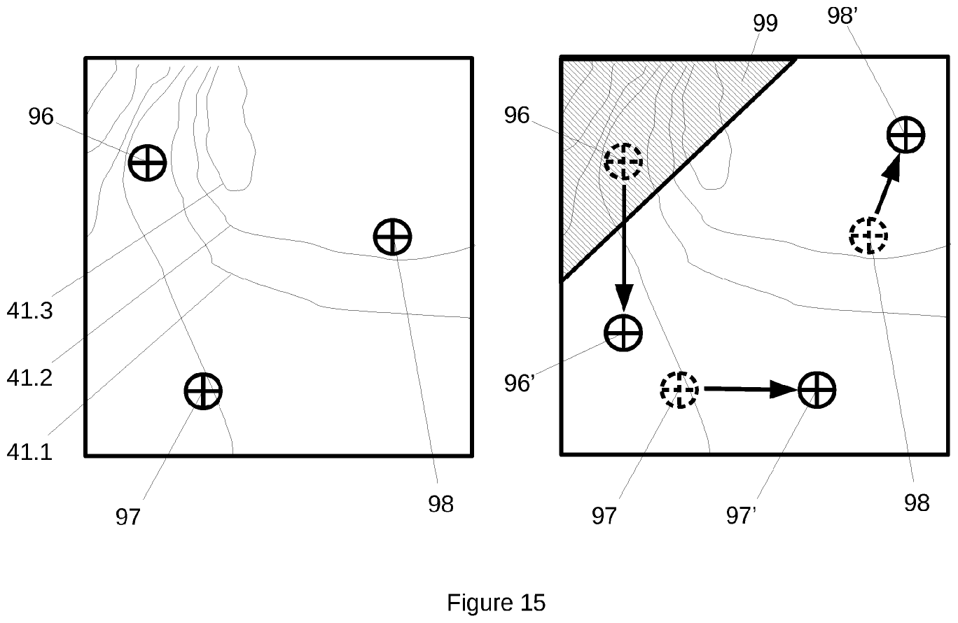

FIG. 15 shows how a region of parameter space, arrived at by processing data such as flow inclination data as measured by converging beam LIDAR, may be excluded and that the parameters may be adjusted in order to avoid conflict with the said exclusion zone, for example during planning of wind farm layout.

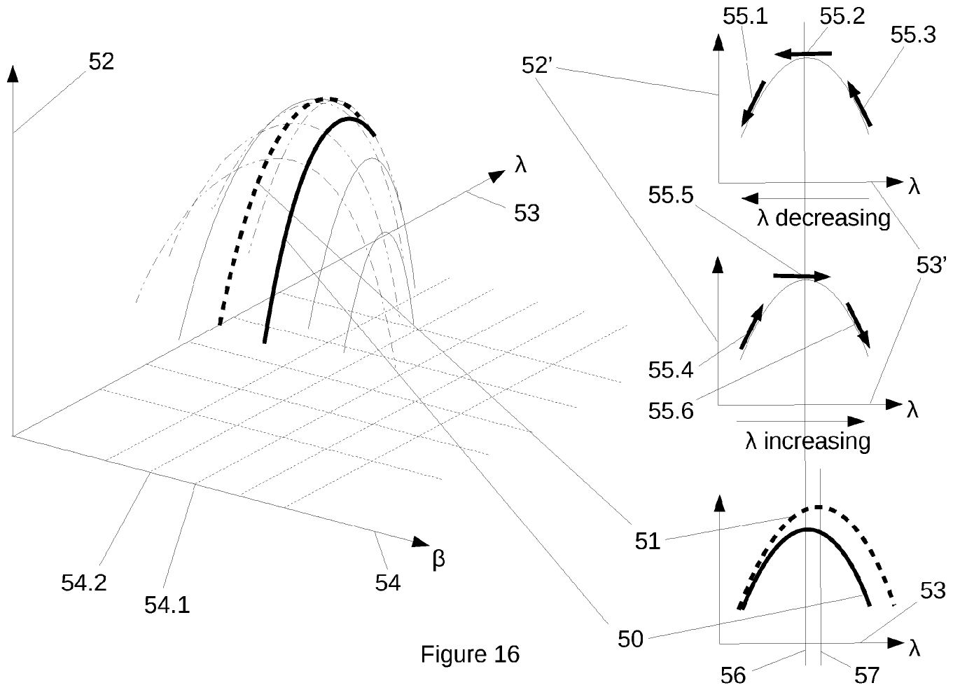

FIG. 16 shows that a control philosophy might aim to maintain operation on one control locus or trajectory whereas potentially there could be a better control locus or trajectory available through adjusting a control parameter.

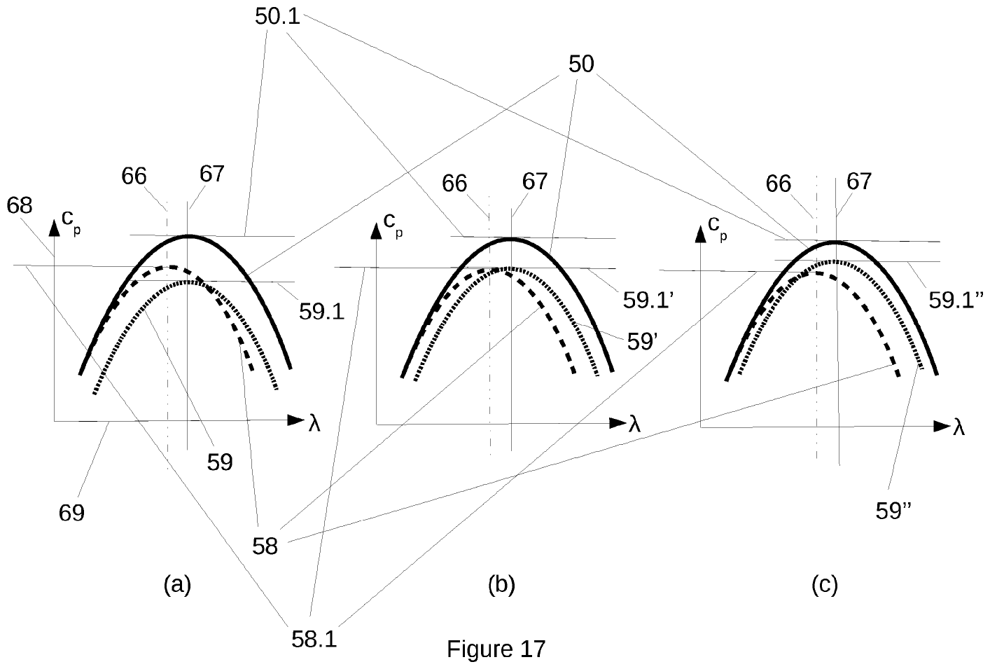

FIG. 17 shows three graphs from left to right respectively with all three graphs showing a control trajectory for an objective function dependent on a parameter. However, the expected theoretical objective function may be reduced by amounts respectively dependent on a sub-optimal parameter, such as but not limited to a misalignment angle. If we alter a second control parameter, such as but not limited to blade pitch angle, then it could be possible to adjust the control trajectory and the respective outcome may be (a) favourable, (b) neutral or (c) unfavourable.

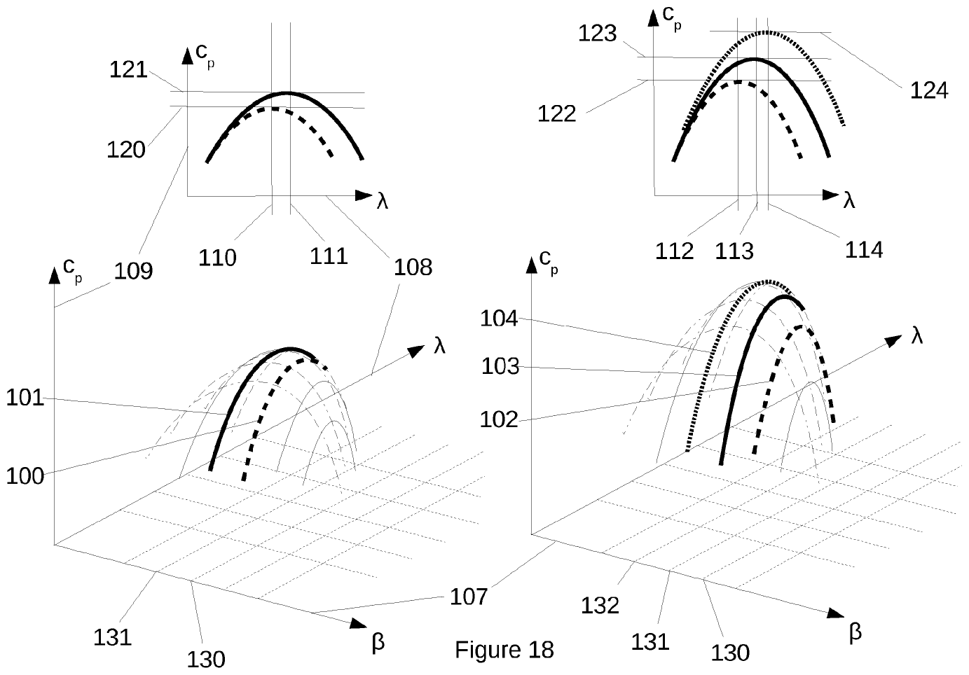

FIG. 18 shows on the left side an expected control surface with different control trajectories according to a particular parameter such that the trajectory is expected to maximise best the objective function for a given parameter setting. However, an alternative control methodology or one or more further parameter settings elsewhere may permit operation on an improved control surface, depicted on the right, in which case a different parameter setting maximises best the objective function.

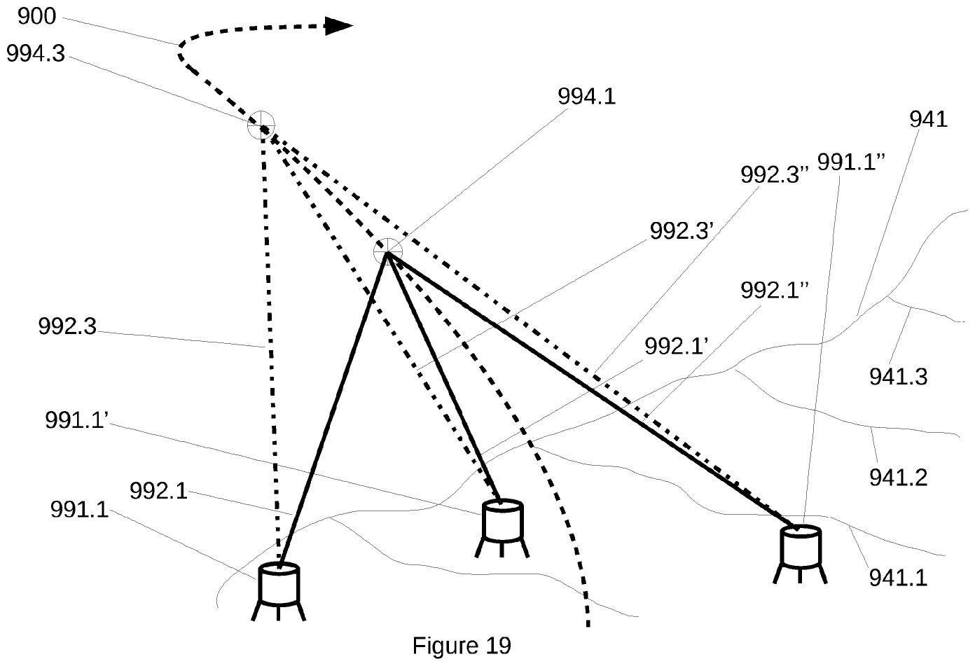

FIG. 19 shows a plurality of ground mounted LIDARs converging their beams to a plurality of measurement points on a trajectory, such as a vehicle trajectory.

FIG. 1 in detail shows the plan view of a horizontal axis wind turbine including rotor blades (5), rotor hub (6) and nacelle (7), firstly (on the left) when the rotor axis (8) is aligned with the horizontal wind direction (1), and secondly (on the right) when the rotor axis (8) is horizontally misaligned with a horizontal wind direction (2) by an angle (3) due to a yaw error. One may consider the wind velocity vector field to be both horizontal and parallel across the whole rotor as it impinges a plane (4) through the rotor hub centre and perpendicular to the rotor axis.

FIG. 2 in detail shows the aerodynamic forces of lift (16) and drag (26) on a wind turbine blade element with centre of mass (23), with pressure side (21) and suction side (20), at a radius r from the rotor axis. The relative air speed (22) and aerodynamic angle of attack (14) are provided in a first component by the wind velocity vₓ (12), and in a second component by r·Ω, the rotational speed (13) of the blade element within the rotor plane (11) where Ω represents angular speed. For a given relative air speed, a lift characteristic (19) of the air-foil shape may be plotted on a graph relating the angle of attack as abscissa (17) and coefficient of lift as ordinate (18). The blade may have pitch angle, β_{PITCH}, motorisation. A blade shape may include a twist angle, β_{TWIST}, which is a function of r. The air-foil chord connects the leading edge (24) and trailing edge (25) of a blade element, and is shown extended (10) beyond the air-foil element. The aerodynamic angle of attack (14) is the angle between the air-foil chord and the line (27), through the blade element centre, of the overall relative air flow velocity. This air flow velocity is relative to the air-foil element, within the plane of the air-foil element as its elemental width, dr, tends to zero. The angle between the rotor plane (11) and the air-foil chord is β, the sum (15) of blade twist and blade pitch motorisation angles. This means that the aerodynamic angle of attack (14) is altered by blade pitch motorisation which is the basis of pitch control.

FIG. 3 in detail shows, in the case of zero rotor axis tilt and rotor blade element motion through a vertical plane, how a horizontal misalignment θₕ (30), of the rotor axis (31), with respect to the wind velocity direction gives rise to a cyclic variation in both angle of attack and relative airspeed for any given blade element. Four views from different lines of sight shown by four Cartesian axis sets (33.1, 33.2, 33.3, 33.4), always viewing along the blade length towards the rotor centre, are shown per 90 degrees interval of blade rotation ψ (32) around the rotor axis. The rotor axis is parallel with the x-axis and the yz-plane is the rotor plane. The four different views show how the resultant velocity triangle varies between the four cases with the overall wind speed in the x-direction reduced by an amount (34.1, 34.2, 34.3, 34.4) which depends on cos(eh), whilst the relative wind speed within the rotor plane is cyclically adjusted by an amount (35.1, 35.2, 35.3, 35.4). At the four positions the rotor blade element is moving through the rotor plane in the negative z-direction, negative y-direction, positive z-direction and positive y-direction respectively and therefore in the first and third positions the relative airspeed of the component in the rotor plane (11) is unaffected by the yaw error whilst in the second and fourth positions at the bottom and top of the rotor the yaw error defined in this sign convention acts to decrease (35.2) and increase (35.4) the relative airspeed component within the rotor plane. Considering the wind velocity vector (37) in the (non-rotating) rotor plane reference frame one may derive equations, such as but not limited to (36)

tan(β+α)=(v·cos θₕ)/(r·Ω−v·sin θₕ·sin ψ),

which allow further calculation of a cyclic pitch control adjustment in order to cancel the effect of yaw error on aerodynamic angle of attack, or indeed on another chosen parameter.

FIG. 4 in detail shows a wind turbine (40) situated on a Scottish hillside (41) in the case where the wind is not horizontal but running substantially parallel to the terrain and from a direction where the terrain is sloping downward from the turbine such that the wind inflow (42) is running up the hill toward the turbine at a non-horizontal flow inclination angle (43) which may be effectively increased by a rotor axis tilt angle (44) separating the rotor axis (45) from a horizontal plane (46).

FIG. 5 in detail shows the same turbine in another orientation (40′) where the wind inflow (42′) is coming from the opposite direction from the upper hillside (41) and where the rotated rotor axis (45′) has the same rotor axis tilt angle (44) to the horizontal plane (46). In this case the rotor tilt angle effectively reduces flow misalignment, with respect to the rotor axis, due to the flow inclination angle (43′).

FIG. 6 in detail shows bin-averaged operational power curve data from a wind turbine situated on a Scottish hillside, for two wind direction data partitions from opposite wind direction sectors (180 degrees apart) where the average power plotted per the ordinate axis (61) for each wind speed data partition (60) on the abscissa axis (62) is found to be substantially greater throughout the power curve rise for one wind direction sector (the upper trace 63), as compared with the other wind direction sector (the lower trace 64). Each data point is shown with error bars, in this case indicating the standard deviations of abscissa and ordinate quantities within each wind speed bin or data partition.

FIG. 7 in detail shows a number of different flow inclination conditions where the tilt angle exacerbates or counteracts misalignment, which may be taken into account during wind farm planning and turbine layout. A turbine (70) is depicted situated in six different cases of sloping terrain (71.1, 71.2, 71.3, 71.4, 71.5, 71.6) where six different cases of wind flow (77.1, 77.2, 77.3, 77.4, 77.5, 77.6) may be substantially parallel to the slope of the terrain. The wind flow vertical flow inclination angle, θᵥ (75), to the horizontal plane (73) is added to the rotor axis (72) tilt angle, θₜᵢₗₜ (76), in order to arrive at an overall vertical misalignment angle εᵥ. A consistent angle sign convention is shown where θₜᵢₗₜ is positive. It is appreciated that various different signing conventions could be possible and are equivalent to one another.

FIG. 8 in detail shows a vertical misalignment (arising from the sum of vertical flow inclination, θᵥ, and rotor axis tilt angle, θₜᵢₗₜ), with respect to the rotor axis. The overall misalignment of the wind velocity, 83, gives rise to a cyclic variation in both angle of attack and relative airspeed for any given blade element. Four views from different lines of sight shown by four Cartesian axis sets (33.1, 33.2, 33.3, 33.4), always viewing along the blade length towards the rotor centre, are shown per 90 degrees interval of blade rotation ψ (32) around the rotor axis. The rotor axis is parallel with the x-axis and the yz-plane is the rotor plane. The four different views show how the resultant velocity triangle varies between the four cases with the overall wind speed in the x-direction reduced by an amount (81.1, 81.2, 81.3, 81.4) which depends on cos(θᵥ+θₜᵢₗₜ), whilst the relative wind speed within the rotor plane is cyclically adjusted by an amount (82.1, 82.2, 82.3, 82.4). At the four positions the rotor blade element is moving through the rotor plane in the negative z-direction, negative y-direction, positive z-direction and positive y-direction respectively and therefore in the second and fourth positions at the bottom and top of the rotor the relative airspeed of the component in the rotor plane (11) is unaffected by the vertical misalignment error whilst in the first and third positions the yaw error defined in this sign convention acts to increase (82.1) and decrease (82.3) the relative airspeed component within the rotor plane. Considering the wind velocity vector (83) in the (non-rotating) rotor plane reference frame on may derive equations which allow for cyclic pitch control adjustment to cancel the effect of vertical misalignment on aerodynamic angle of attack or another chosen parameter, such as but not limited to (84)

tan(β+α)=(v·cos(θᵥ+θₜᵢₗₜ))/(r·Ω+v·sin(θᵥ+θₜᵢₗₜ)·cos ψ).

FIG. 9 in detail shows how a wind turbine rotor, situated at a given map grid location (96) in terrain (41), rotates from a position in one yaw direction (40) to a position in an opposite yaw direction (40′). In rotating through 360 degrees of yaw direction the spinning rotor may describe a volume which is not quite perfectly spherical but rather a slightly oblate spheroid contained within a minimal ellipsoid (90) volume. Contours (41.1, 41.2, 41.3) such as contours of varying heights above mean sea level are shown.

FIG. 10 in detail shows three LIDARs (91.1, 91.1′, 91.1″) ground mounted within terrain (41) may converge their beams (respectively 92.1, 92.1′ and 92.1″) to a measurement point (94.1) within the volume (90) which would be swept out by a turbine of known dimensions if it were installed at a given map grid location (96).

FIG. 11 in detail shows how three LIDARs (91.1, 91.1′, 91.1″) ground mounted within terrain (41) may converge their beams (respectively 92.1, 92.1′ and 92.1″) to a first measurement point (94.1) and subsequently they may converge their beams (now labelled respectively 92.2, 92.2′ and 92.2″) to a second measurement point (94.2). The three LIDARs may cooperatively converge their beams to a plurality of points arranged on a vertical axis above a given map grid location (96), so as to replicate wind measurements which might be provided by a meteorological mast if it were installed at the given location (96).

FIG. 12 in detail shows how three LIDARs (91.1, 91.1′, 91.1″) ground mounted within terrain (41) may converge their beams to a plurality of measurement points throughout a planar region which might be indicative of an expected rotor plane orientation when the wind turbine rotor is pointing toward a potential wind direction. The LIDARs converge their beams (respectively 92.1, 92.1′ and 92.1″) to a first measurement point (94.1), positioned above a map grid location (96) and at the hub height of a potential turbine location, and subsequently they may converge their beams (now labelled respectively 92.3, 92.3′ and 92.3″) to a second measurement point (94.3).

FIG. 13 in detail shows how three LIDARs (91.1, 91.1′, 91.1″) ground mounted within terrain (41) may converge their beams to a plurality of measurement points throughout an ellipsoid volume (90). In this example the plurality of points are arranged on the vertices of a cube (95) but in general they may be arranged in any regular or irregular shape, including three-dimensional Lissajous figures for efficient beam scanning traversal of all measurement points. The LIDARs converge their beams (respectively 92.1, 92.1′ and 92.1″) to a first measurement point (94.1), positioned above a given map grid location (96) and at the hub height of a potential turbine location, and subsequently they may converge their beams (now labelled respectively 92.4, 92.4′ and 92.4″) to a second measurement point (94.4).

FIG. 14 in detail shows how three LIDARs (91.1, 91.1′, 91.1″) ground mounted within terrain (41) may converge their beams to one or more points surrounding one possible location (96), and also to one or more points at another possible location (96′), possibly replicating the measurements of multiple meteorological masts through a single triple LIDAR deployment. The LIDARs converge their beams (respectively 92.1, 92.1′ and 92.1″) to a first measurement point (94.1), positioned above a first map grid location (96) and at the hub height of a potential turbine location, and subsequently they may converge their beams (respectively 92.2, 92.2′ and 92.2″) to a second measurement point (94.2) at another height above the same map grid location (96). The LIDARs may then converge their beams (respectively 92.5, 92.5′ and 92.5″) to another measurement point (94.5), positioned above a second map grid location (96′) and at the hub height of an alternative potential turbine location. Any number of map grid locations and measurement points surrounding a given map grid location may be undertaken.

FIG. 15 in detail shows how a region of parameter space, arrived at by processing data such as flow inclination data optionally measured by converging beam LIDAR, may be excluded and that the parameters may be adjusted in order to avoid conflict with the said exclusion zone, for example during planning of wind farm layout. On the left is shown a first wind farm layout for three turbines indicated at map grid locations (96, 97, 98) along with map contours (41.1, 41.2, 41.3) indicating height above mean sea level. On the right is shown the same map section where a region (99) has been excluded and a second layout with alternative turbine locations (respectively 96′, 97′, 98′) is shown. In this case the region is triangular in plan but in general an excluded region may be of any shape.

FIG. 16 in detail shows that a control philosophy might aim to maintain operation on one control locus or trajectory whereas potentially there could be a better control locus or trajectory available through adjusting a control parameter. On the left hand side is shown a control surface with an objective function (52) which depends on two parameters, β (54) and A (53). In one embodiment β is blade pitch angle and λ is tip speed ratio, whilst the objective function could be power coefficient. However, many possible control surfaces relating other parameters and various possible objective functions are also possible. In the lower right is shown the same three-dimensional surface projected into two dimensions in order to graph the objective function (52) dependence on λ (53). If the first parameter, β (54), is at a first value (54.1) then the system follows a first control trajectory (50), with a maximum objective function when A is at a particular value (56). If the first parameter is set to second value (54.2) then the system follows a second control trajectory (51) which may be preferable to the first control trajectory since it produces higher values of an objective function (52) when λ is at a particular value (57). The upper two graphs on the right hand side show a possible control methodology where a parameter (53′) may be observed and adjusted according to variation in the objective function, also observed. In case (55.1) where λ is decreasing, and the objective function is also decreasing, then one increases λ in order to increase the objective function. In case (55.3) where λ is decreasing and the objective function is increasing, then one continues to decrease λ with the intention of control towards a globally or locally optimal operating point. In case (55.4) where λ is increasing and the objective function is increasing, then one continues to increase λ in order to increase the objective function. In case (55.6) where λ is increasing and the objective function is decreasing, then one decreases A with the intention of control towards a globally or locally optimal operating point. When the objective function is stationary despite increasing (55.5) or decreasing (55.2) A then one has confidence that operation is globally or locally optimal, at least for the present control trajectory, and no action is needed until this optimal situation changes. However, it is possible that with an altered setting of a parameter β one might operate on another control trajectory which has an even better optimum. This shows that control methodology which does not account for all parameter dimensions may operate sub-optimally, as compared with one which accounts for all, or a greater set of, parameter dimensions.

FIG. 17 in detail shows three graphs from left to right respectively with all three graphs showing a control trajectory (50) for an objective function (68) dependent on a parameter λ (69). However, the expected theoretical objective function (50) may be reduced from a value (50.1) to levels (59.1, 59.1′, 59.1″) respectively according to the actual control trajectory (respectively 59, 59′, 59″), depending on a sub-optimal parameter such as but not limited to a misalignment angle. If we alter a second control parameter, β, such as but not limited to a blade pitch angle, then it could be possible to adjust the control trajectory and the respective outcome may be (a) favourable (59), (b) neutral (59′) or (c) unfavourable (59″). The parameter Δ (69) has expected optimal value (67) for control trajectories prior to altering β (50, 59, 59′, 59″) but the trajectory 58 may reach a maximum at a different value (66) of λ.

FIG. 18 in detail shows on the left side an expected control surface with different control trajectories according to a particular parameter such that the trajectory is expected to maximise best the objective function for a given parameter setting. A control surface is plotted as an objective function value on a vertical axis (109) depending on parameters λ and β quantified according to horizontal axes (108, 107 respectively). In the left hand graph changing β from a first parameter setting 130 to a second parameter setting 131 implies a shift in control trajectory from a first locus 100 to a second locus 101 which improves the maximal objective function value from 120 to 121, occurring when λ is 110 and 111 respectively. However, an alternative control methodology or one or more further parameter settings elsewhere may permit operation on an improved control surface, depicted on the right, in which case a different parameter setting maximises best the objective function. In this case changing β from a first parameter setting 130 to a second setting 131 and to a third setting of 132 results in a change in control trajectory from 102 to 103 to 104 respectively, which loci include a maximum objective function value of 122, 123 and 124 respectively, occurring at A values of 112, 113, 114 respectively.

FIG. 19 in detail shows three LIDARs (991.1, 991.1′, 991.1″) within terrain (941) converging beams (respectively 992.1, 992.1′ and 992.1″) to a first point (994.1), and subsequently (with beams 992.3, 992.3′ and 992.3″) to a second point (994.3) on a trajectory (900).

Some clarification of wording follows. It is known that “wind data” may refer to any one or more of: wind speed, wind velocity component, wind velocity, gusts, wind direction, horizontal wind direction, horizontal wind speed, turbulence, turbulence intensity, horizontal wind shear, horizontal wind veer, vertical wind shear, vertical wind veer, flow inclination angle to the horizontal plane, air density, wind pressure; as well as statistics thereof (including but not limited to arithmetic mean, standard deviation, 10-minute temporal average, 3-second temporal average, 1-second temporal average) and statistical distributions thereof. The term “LIDAR data” may refer to any type of “wind data” as measured by a LIDAR, or it may refer to any type of “LIDAR system data” or “LIDAR system parameter”. In general wind data is a special case of fluid data. Wind flow is a special case of fluid flow. Air is a special case of a fluid. A wind driven turbine, also known as a wind turbine, is a special case of a fluid driven turbine. It is noted that data such as turbine data or wind data may be arrived at through one or more of: theory, calculation (including calculation within computer simulation or computer model), or through use of one or more measurement sensor. Any data may be referred to as a parameter. An item of turbine data may be referred to as a turbine parameter. An item of LIDAR data may be referred to as a LIDAR parameter. An item of wind data may be referred to as a wind parameter. An item of load data may be referred to as a load parameter. An item of environmental data may be referred to as an environmental parameter. An item of machine learning data may be referred to as a machine learning parameter. An item of neural network data may be referred to as a neural network parameter.

A position may be absolute or relative. An orientation may be absolute or relative. A position or orientation may be specified with respect to any coordinate frame of reference.

A LIDAR may be a pulsed LIDAR. A LIDAR such as a pulsed LIDAR may employ range gating or timing in order to estimate distance of a measurement. A LIDAR may be a CW (continuous wave) LIDAR. A LIDAR may incorporate a fibre laser. A LIDAR may incorporate a safety shutter. A LIDAR may incorporate focal length control. A LIDAR may be provided with a means of beam steering, or beam direction switching. A means of beam steering may utilise one or more rotating prism. A means of beam steering may be a Risley prism beam steerer. A means of beam steering may utilise one or more rotating mirror or reflective surface. Other remote sensing methods such as SODAR, RADAR and SONAR may also be used instead of LIDAR.

It is considered that a LIDAR may process electromagnetic radiation or light of any possible wavelength. Without loss of generality it is noted that infra-red systems may be preferred for scattering within the Earth's atmosphere at relatively low ranges of metres to kilometres, with the predominant scattering arising from microscopic particulates and aerosols, whilst at longer ranges such as many kilometres into a section of the atmosphere such as the upper atmosphere where particulates are of low density then molecular scattering may be preferred possibly at different wavelengths such as ultraviolet wavelengths. LIDAR system parameters may be tailored for the intended measurement fluid environment, measurement range, and so on. The spectral transmission of the fluid medium may be taken into account. Underwater, perhaps for tidal turbines, optical wavelengths may be employed, such as but not limited to blue or green wavelengths.

Where beam steering is referred to it should be understood that this may also refer to beam switching. Wherever beam steering is referred to for a LIDAR measurement system it should be understood that this may optionally refer to LIDAR measurement range control, either by timing gates for a pulsed LIDAR system, or by focus range control in the case of a continuous wave LIDAR system. Beam switching may be considered as a discrete form or beam steering whereas, in general, beam steering allows continuous variation of a beam direction through one or more angle. Beam steering and switching is considered as variation of at least one angular direction parameter. Various methods of optical path switching may be contemplated by a person skilled in the art, including but not limited to liquid crystal methods, optoelectronic methods, beam splitters combined with shutters, mechanical rotation of lenses, prisms or mirrors, etc. A cascade of beam splitters may split one beam into any number of sub-beams which may be controlled independently in angle or in one or more other beam parameter. Optionally, amplifiers of various types might be applied in order to increase the power of any of the sub-beams. Shutters may be applied in order to stop the power of any individual sub-beam within the cascade. Preferably the cascade could employ beam switches in order to divert the beam path through the cascade with as little wasted beam power as possible. Switches could be arranged in N tiers. If each switch is a two-way switch then N tiers allows for 2 to the power of N different paths. If each switch is a three-way switch then N tiers allows for 3 to the power of N different beam paths, and so on. Therefore one may envisage an optical head which receives M total output beam paths directed in M different directions. A miniaturised system employing optical fibres, optionally employing fibre laser amplifier, is contemplated although other systems may be applicable including but not limited to microwave wave guides.

For the avoidance of doubt it is noted that the terminology of the word “beam” may refer to a mechanical arm whereas in this present text the word “beam” is used to indicate a linear flow of energy, such as but not limited to a laser beam. The beam is substantially linear, or pencil like, in order that beams may converge to a point. It is acknowledged that whilst laser beams are generally considered to be linear, notwithstanding their finite beam width and focus which may degrade especially at long range, other beams of energy may not be considered typically as linear. For instance a RADAR beam may have a large angular width according to an antenna gain pattern extending through one or more angular range. The antenna gain through an angular range may also incorporate “side lobes”. In this respect an antenna gain may be very similar to a diffraction pattern such as a single slit diffraction pattern. An isotropic antenna pattern with equal gain in all angular directions cannot give any indication of probable angular direction of a target and therefore the target line of sight direction, which is relevant to any measured Doppler shift remains unknown. In order to determine the line of sight relative speed via Doppler shift one must have an indication of direction. Therefore in the present invention the beams are considered to be of narrow angular width and substantially “pencil-like”. It is noted that “pencil-like” RADAR beams with narrow beam width may be achieved through methods such as the phased array of many antennas combined as if they were one. To this extent a single RADAR or SONAR or SODAR or optical light Doppler processor may be a phased array.

1. A system to provide data in order to calculate, adjust or constrain at least one parameter of a turbine.

2. The system of claim 1 where the at least one parameter is calculated, adjusted or constrained with the purpose of increasing the overall lifetime production of a turbine by one or more of (i) extending its operational lifetime, (ii) by increasing its average output power, or (iii) reducing maintenance costs.

3. The system of any preceding claim where fluid data are at least in part provided by measurement instruments.

4. The system of any preceding claim where fluid data is provided from a plurality of points in space-time.

5. The system of any preceding claim where, at one or more points in space-time, the data describes the fluid medium, including one or more of: (i) fluid density, (ii) temperature, (iii) pressure, (iv) humidity, (v) molecular composition, (vi) electromagnetic force fields, (vii) gravitational force fields present within the fluid medium.

6. The system of any preceding claim where the data includes three-dimensional fluid velocity data.

7. The system of claim 6 where the data includes three-dimensional wind velocity data provided by at least three Doppler LIDAR beams arranged in order to converge to a given measurement point with three distinct lines of sight such that the three respective unit direction vectors, which are individually parallel to their three respective beam directions, are mutually non-parallel and non-co-planar and therefore have a scalar triple product magnitude which is non-zero.

8. The system of claim 7 where at least three Doppler LIDARs incorporate beam steering for at least one of the Doppler LIDAR beams, where a given LIDAR unit automatically aims its beam at a received, commanded, generated or programmed measurement point in space by employing data from sensors of its own LIDAR unit position and LIDAR unit orientation, such as but not limited to satellite positioning sensors (such as GPS sensors, or differential GPS sensors), roll sensors, pitch sensors, and yaw sensors.

9. The system of any preceding claim where the parameter calculation, adjustment or constraint is performed for a particular sub-domain of the overall parameter domain for the turbine.

10. The system of 9 where the sub-domain is an angular range of nacelle yaw direction, or an angular range of wind direction; thereby enabling direction sector-based calculation, adjustment or constraint.

11. The system of any preceding claim where fluid velocity data is provided from one or more points within a given volume, optionally the volume which would be swept out by a turbine rotor of given dimensions if the turbine rotor were deployed at a given location.

12. The system of claim 11 where the fluid velocity data is used to ascertain at the one or more points a bin-partitioned statistical distribution for one or more of (i) rotor averaged fluid speed (velocity magnitude), (ii) rotor averaged horizontal fluid speed, (iii) rotor averaged fluid horizontal direction, or (iv) a rotor averaged fluid velocity component with reference to a particular direction, (v) rotor averaged wind shear, (vi) rotor averaged wind veer, (vii) rotor averaged flow inclination angle, (viii) rotor averaged turbulence intensity.

13. The system of any preceding claim where the data is or includes operational data from an operating wind turbine.

14. The system of any preceding claim where the data are at least in part calculated by, or processed within, a computer model; where the model is optionally provided with fluid flow data from measurement instruments.

15. The system of claim 14 where the model is part of any one or more of (i) a LIDAR assisted turbine control system, (ii) a model predictive control system, (iii) an open loop control system, (iv) a closed loop control system.

16. The system of any preceding claim where the data includes terrain shape data of any type, such as but not limited to (i) satellite navigation data, (ii) grid data of northing, easting and elevation above mean sea level, (iii) contour data, (iv) LIDAR terrain mapping data or (v) any other type of survey data.

17. The system of any preceding claim where a parameter is adjusted to match fluid flow conditions at a specific turbine deployment location, either statically to account for the general local conditions, or dynamically to account for changing conditions.

18. The system of any preceding claim where a turbine rotor axis tilt angle parameter is adjusted to match parameters of a specific turbine and its environment, either statically, or dynamically to account for changing conditions in which case the system incorporates turbine rotor axis tilt motorisation, and optionally incorporates both tilt axis and yaw axis motorisation, or an equivalent motorisation throughout a solid angle; optionally incorporating further parameters to constrain the system with respect to the said motorisation, which constraint parameters themselves may be static or dynamically adjustable.

19. The system of any preceding claim where the at least one parameter of a turbine is any one or more of (i) the location position of a turbine base (such as WGS84 coordinates or grid northing and easting coordinates), (ii) the rotor diameter, (iii) the hub height, (iv) the rotor lower tip height above ground, (v) the rotor top tip height above ground, (vi) rotor axis tilt angle, (vii) a blade shape parameter, (viii) a rotor pre-cone geometric parameter, (ix) a smart rotor adjustable geometry parameter, (x) a turbine rotor tower parameter, (xi) a turbine tower foundation parameter, (xii) an adjustable tower height parameter, or (xiii) a parameter of a mounting frame upon which a turbine rotor is mounted.

20. The system of any preceding claim where the turbine is a notional turbine within a turbine farm planning project, including the possibility of a re-powering project, and including the possibility of a retrofit upgrade project, where fluid data, or one or more exclusion zone calculated from it, or one or more turbine parameters calculated from it, are employed for improving turbine array layout, or checking constraints relating to correct turbine category selection and correct turbine deployment parameters within a given turbine array layout, such as but not limited to constraints on any one or more of (i) turbulence intensity, (ii) shear, (iii) veer, (iv) flow inclination angle, (v) gust conditions, (vi) fatigue loads, (vii) extreme/ultimate loads, (viii) noise amplitude, (ix) noise tonality or spectral limits, (x) three-dimensional turbulence components, (xi) turbulence spectral limits, (xii) vibration limits, (xiii) wind speed, or (xiv) at least one component of three-dimensional wind velocity.

21. The system of any preceding claim where data or parameters are provided for checking whether insurance conditions are met, whether turbine planning conditions are met, or whether turbine supply, turbine service, turbine warranty or turbine maintenance contractual conditions are met with respect to a given turbine, or are met with respect to a given turbine farm array layout.

22. The system of any preceding claim where the at least one parameter of a turbine is an operational control parameter within an operating turbine.

23. The system of claim 22 where at least one operational control parameter is for turbine blade pitch angle control, including but not limited to (i) collective blade pitch control, (ii) cyclic pitch control, (iii) individual pitch control, (iv) independent blade control (including the possibility of accounting for non-identical blades and rotor mass/force imbalance), (v) non-cyclic pitch control accounting for variability of wind around and across large rotor areas.

24. The system of claim 23 where the blade pitch angle control is for the purpose of cancelling or partially counteracting the cyclic or non-cyclic variation in a fluid-dynamic angle of attack parameter, due to any one or more of: (i) turbine rotor yaw misalignment, (ii) turbine rotor axis tilt, (iii) vertical flow inclination angle, (iv) linear vertical shear, (v) linear vertical veer, (vi) linear horizontal shear, (vii) linear horizontal veer, (viii) non-linear vertical shear, (ix) non-linear vertical veer, (x) non-linear horizontal shear, (xi) non-linear horizontal veer, (xii) rotor pre-cone geometry, (xiii) rotor shape change during operation, (xiv) turbine tower bending, (xv) rotor flow induction (including bow wave and wake), (xvi) change of vertical flow inclination angle across a rotor, (xvii) smart rotor shape change, or (xviii) general variation of a wind velocity vector field across the turbine rotor as represented by a set of one or more velocity samples at respectively one or more position in time and space.

25. The system of claim 22, claim 23 or claim 24 where at least one operational control parameter is provided for at least one or more of (i) yaw control, (ii) generator-torque control, (iii) storm shut-down/restart, (iv) noise control, (v) curtailment control, (vi) loads control or damping, (vii) vibration control or damping, (viii) blade flaps control, (ix) adjustable blade or smart rotor control, (x) output electrical power quality control, (xi) rotor axis tilt control, (xii) turbine start up.

26. The system of any preceding claim where a wind speed parameter is multiplied or divided by a factor; such as the trigonometric cosine of a misalignment angle, or the trigonometric cosine of an effective misalignment angle; in order to account for wind velocity misalignment angle with respect to the wind turbine rotor axis, or misalignment with respect to a horizontal axis within the same vertical plane as the rotor axis, before being employed in a governor, a trigger, a control LUT (Look Up Table) or a control functional model, for any one or more of: (i) blade pitch set point, (ii) rotor RPM set point, (iii) power quality factor set point, (iv) active power set point, (v) reactive power set point, (vi) start up yaw enable, (vii) storm shut-down initiation, (viii) storm re-start, (ix) an operational control mode transition, or (x) a maximum power tracking algorithm.

27. The system of any preceding claim where a blade element model is employed to calculate fluid-dynamic contributions from along a turbine blade, optionally employing interpolation between a discrete set of blade model elements in order to provide a continuous model; optionally accounting for blade bending modes as calculated by computer model, or as measured with sensors; optionally accounting for turbine tower bending modes as calculated by computer model, or as measured with sensors.

28. The system of any preceding claim where the data are employed to specify parameters of a retrofit control unit, or are provided to a retrofit control unit which may be installed within an existing or future planned turbine and where the retrofit control unit provides the at least one parameter of a turbine.

29. The system of claim 28 where the retrofit control unit is inserted in series between an existing control unit and an actuator, thereby enabling over-ride, adjustment or constraint of the original controller output signal by a replacement output signal which is the signal provided as a new set point to the actuator.

30. The system of claim 28 or claim 29 where the retrofit control unit is a retrofit blade pitch control unit and its actuator is a blade pitch angle actuator such as an electric motor or hydraulic motor system, optionally incorporating a relative or absolute pitch angle encoder.

31. The system of claim 28 or claim 29 or claim 30 further comprising a fail safe signal switch by-pass system which ensures that by default the original control unit output will be provided as output from the retrofit control unit and that this signal is only over-ridden, adjusted or constrained when the retrofit control unit has power and is not provided with any indication that its control function would be incorrect.

32. The system of claim 28 or claim 29 or claim 30 or claim 31 where a retrofit controller output set point is vetoed, over-ridden or attenuated in favour of the original set point, depending on the value of a condition-monitoring signal, a load sensor signal, a noise sensor signal, a wind parameter, a turbine parameter, or another parameter.

33. The system of any preceding claim where operational data are gathered prior to and after a parameter change in order to quantify an improvement or degradation at the time of the parameter change, such as but not limited to a change in annual energy production, or an equivalent increased revenue value.

34. The system of any preceding claim where a computer program calculates wind velocity reconstruction error based on the three deployment locations of a triple LIDAR and one or more provided measurement locations allowing for calculation of three respective unit vectors along the three Doppler LIDAR beams which are required to converge at the one or more measurement locations; optionally allowing for the beam steering angle uncertainties; optionally allowing for the line of sight Doppler velocity uncertainties; thereby allowing the optimisation or improvement of LIDAR deployment configuration within a converging beam LIDAR measurement campaign, optionally employing terrain data such as grid data or contour data, and allowing a three-dimensional velocity uncertainty to be quantified alongside the reconstruction of any given wind velocity measurement, optionally allowing for the exclusion of one or more LIDAR deployment configurations, and optionally allowing for the efficient planning of triple LIDAR deployment locations in order to adequately sample a given region or set of points whilst maintaining measurement uncertainty within an upper bound of acceptability.

35. The system of any preceding claim where the data includes turbine power curve data, consisting of average fluid speed versus average power data pairs from a series of operational time intervals, which overall data set may be split into one or more partitions according to the value of another operational parameter, such as but not limited to average nacelle direction angle, or average fluid direction angle where averages are calculated per time interval.

36. The system of claim 35 where energy production capability per data partition may be compared by bin-wise multiplication of the corresponding power curve histogram per partition with a fluid speed frequency histogram employing the same fluid speed bin ranges as for the power curve; optionally allowing calculation of relative energy productivity per data partition which is the ratio of energy production capability per partition divided by the maximum energy production capability of all the partitions; and optionally allowing for calculation of production losses per data partition by firstly forming the bin-wise difference between the power curve histogram for the given partition and the power curve histogram of the partition having maximum energy production of all the partitions, and secondly undertaking bin-wise multiplication of this difference histogram with a fluid speed frequency histogram indicating the fluid speed distribution specific to the given data partition.

37. The system of claim 34 or claim 35 where the data set is cut to exclude time intervals when one or more parameter is outside of a given range in order that the energy losses calculation focuses on particular operating regime of the turbine, such as but not limited to “Region 2 Control” which might potentially be represented for some turbines by selecting power curve data within an operating regime of average wind speed within a particular range, such as but not limited to the range 2-12 m/s.

38. The system of claim 35 or claim 36 or claim 37 where an energy losses calculation for a given operating regime indicate that a control adjustment or controller retrofit may be beneficial within that operating regime, and where the energy losses calculation may indicate potential gains in annual energy production that might be obtained by the wind turbine owner when applying the control adjustment or retrofit.

39. The system of claim 35 or claim 36 or claim 37 or claim 38 where energy losses calculation, or energy production capability per data partition, or energy losses per data partition, or energy losses per operating regime, or energy production capability per operating regime, is automatically calculated and provided within a turbine SCADA (Supervisory Control And Data Acquisition) system, either as a numerical data point within the SCADA database or in graphical form within an associated Graphical User Interface.

40. The system of any preceding claim where a dataset is split into partitions according to a first parameter of the dataset (such as but not limited to splitting the data into wind direction ranges), and where a second parameter is calculated from the data within each partition, and where linear or non-linear interpolation is used to produce a unique value of the second parameter, given any distinct value of the first parameter.

41. The system of any preceding claim further incorporating a machine learning component for improving, re-calculating, adjusting, constraining or optimising either (i) at least one parameter of the system, or (ii) a scalar objective function formed from a vector of one or more parameter of the system.

42. The system of claim 41 where the machine learning system employs as training data operational data from either or both of (i) the one turbine, or (ii) one or more other turbine.

43. The system of claim 41 or claim 42 where the at least one parameter is any one or both of: (i) an amplitude or attenuation factor to be applied to a cyclic blade pitch correction which may or may not be sinusoidal, (ii) a phase offset to be applied to a cyclic blade pitch correction.

44. The system of any one of claims 41-43 further comprising a machine learning success measure, where the at least one parameter optimised by the machine learning component, is only employed when the machine learning success measure reaches a required success rate threshold.

45. The system of any one of claims 41-44 where at least one parameter to be improved by the machine learning component is improved only for a particular operating regime as defined by one or more operational parameters, such as but not limited to a given angle range for nacelle yaw direction, or wind direction.

46. The system of any one of claims 41-45 where machine learning is reset or re-run, optionally employing newly available data, within any fixed or rolling window of time or number of rotor revolutions so as to allow for self-tuning or adapting to changing conditions.

47. The system of any preceding claim where the parameter constitutes an alarm or warning.

48. The system of any preceding claim where the turbine is any one of (i) a pump, (ii) a compressor, (iii) an impeller, (iv) a propeller, (v) a helicopter rotor, (vi) a drone rotor.

49. The system of any preceding claim where the turbine parameter is replaced by a vehicle parameter and where the turbine is replaced by a vehicle such as but not limited to (i) a rocket, (ii) a space plane or shuttle, (iii) an aeroplane or airborne vehicle, (iv) a sailing vessel or marine vessel, (v) a lorry or ground vehicle, (vi) a helicopter, (vii) a drone, (viii) a submarine or underwater vessel, or (ix) a hovercraft.

50. The system of claim 49 where a data communication system allows that (i) the vehicle communicates with one or more measurement instrument and transmits data, such as but not limited to vehicle position, to a fluid measurement instrument control system, such as but not limited to LIDAR beam steering control systems, or (ii) one or more measurement instrument communicates at least one parameter, such as but not limited to a fluid velocity parameter, to the vehicle.

51. The system of claim 49 or 50 where a vehicle or its trajectory is governed by at least one parameter relating to any one of (i) an adjustable fin, (ii) rocket motor gimbal/directional thrust angle, (i) an adjustable flap, (iv) an adjustable aileron, (v) an adjustable aerodynamic shape modification, (vi) a rotor blade angle, (vii) steering control, (viii) drive or thrust control, (ix) brakes, (x) eject initiation, (xi) parachute deployment, (xii) self-destruct initiation, (xiii) launch abort/postponement, (xiv) landing abort/postponement, (xv) take off abort/postponement, (xvi) initiate a safety action, (xvii) docking abort/postponement, (xviii) initiate a safety manoeuvre to avoid entering or approaching a particular region of airspace.

52. The system of any one of claims 49-51 where a plurality of vehicles are in mutual communication with at least one measurement instrument, such as but not limited to a converging beam LIDAR, in order to avoid risk of collision between the plurality of vehicles or risk that one of the vehicle trajectories passes outside of a provided spatial or temporal constraint.

53. A method for providing data in order to calculate, adjust or constrain at least one parameter in accordance with any preceding claim

54. A computer system or computer program or instruction set to execute the method of claim 53 in accordance with any preceding claim.
